(19) United States
(12) Patent Application Publication
(10) Pub. No.: US 2007/0217970 A1
(43) Pub. Date: Sep. 20, 2007

(54) Reaction apparatus

(75) Inventors: Kaoru Saito, Shiki-shi (JP); Naotomo Miyamoto, Tokyo (JP); Tadao Yamamoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO. LTD.

(21) Appl. No.: 11/716,875

(22) Filed: Mar. 12, 2007

(30) Foreign Application Priority Data
Mar. 14, 2006 (JP) 2006-069480

(51) Int. Cl. B01J 19/00

(52) U.S. Cl. 422/198

(57) ABSTRACT

Disclosed is a reaction apparatus, comprising a reaction container to receive a supply of a reactant and to cause a reaction of the reactant supplied thereto, wherein the reaction container comprises a hollow box member having a first plate wherein a supplying passage of the reactant is formed, a second plate opposite to the first plate, and a third plate provided continuously with edges of the first and second plates, at least one partition plate which is disposed to partition a space inside the box member and to form a reaction passage through which the reactant flows, the partition plate or each of the partition plates including a diaphragm portion provided substantially in a perpendicular direction to the second plate and a joint portion provided at an end of the diaphragm portion substantially perpendicularly thereto, and the joint portion being joined to an inner surface of the second plate.

### BACKGROUND OF THE INVENTION

1. Field of the Invention

The present invention relates to a reaction apparatus, and particularly to a reaction apparatus for receiving a supply of a reactant and causing a reaction of the reactant supplied thereto.

2. Description of the Related Art

In recent years, development has been progressed for the purpose of mounting a fuel cell as a clean power source having high energy conversion efficiency on an automobile, a portable instrument, and the like. The fuel cell is an apparatus for directly extracting electric energy from chemical energy by electrochemically reacting oxygen in the air and fuel with each other.

A simple substance of hydrogen is an example for the fuel in use of the fuel cell. However, such hydrogen is problematic in handling because it is gas at atmospheric temperature and pressure. As opposed to this, in a reforming fuel cell for reforming liquid fuel containing hydrogen atoms, such as alcohols and gasoline, thereby generating hydrogen, the fuel can easily be stored in a liquid state. The fuel cell requires a reaction apparatus including a reaction container for a vaporizer for vaporizing the liquid fuel and water, a reformer for extracting hydrogen necessary to generate power by reacting the vaporized liquid fuel and high-temperature steam with each other, a carbon monoxide remover for removing carbon monoxide as a by-product of a reforming reaction, and the like.

In order to miniaturize the reforming fuel cell as described above, for example, development of a small reaction apparatus called a micro reactor in which the reaction containers for the vaporizers, the reformers, and the carbon monoxide removers are stacked on one another has been progressed. Here, in some cases, the reaction containers for the vaporizers, the reformers, and the carbon monoxide removers is formed by joining, to one another, metal substrates in which grooves serving as passages of the fuel and the like are formed.

The reaction apparatus as described above is sometimes composed so as to reduce a heat loss in such a manner that a vacuum heat insulation structure is adopted by further housing the reaction apparatus into a heat-insulating container of which inner pressure is reduced. In this case, such a stress to expand the reaction container outward is applied thereto owing to a pressure difference between an inside of the reaction apparatus and an inside of the peripheral heat-insulating container. Therefore, when the metal substrates are thinned for the purpose of weight reduction of each reaction container when forming the reaction container by using the metal substrates, strength of the reaction container is decreased, outer wall surfaces of the reaction container are deformed by the stress, and further, are broken in some cases.

### SUMMARY OF THE INVENTION

The present invention has an advantage in capability of providing a reaction apparatus comprising a reaction container to receive a supply of a reactant and to cause a reaction of the reactant supplied thereto, the reaction apparatus having a configuration in which the reaction container is formed of metal substrates, wherein thicknesses of the metal substrates forming the reaction container can be reduced while maintaining strength of the reaction container.

In order to obtain the advantage described above, according to a first aspect of the present invention, there is provided a reaction apparatus, comprising a reaction container to receive a supply of a reactant and to cause a reaction of the reactant supplied thereto, wherein the reaction container comprises a hollow box member having a first plate wherein a supplying passage of the reactant is formed, a second plate opposite to the first plate, and a third plate provided continuously with an edge of the first plate and an edge of the second plate; and at least one partition plate which is disposed to partition a space inside the box member and to form a reaction passage through which the reactant flows, and are joined to an inner surface of the second plate.

In order to obtain the advantage described above, according to a second aspect of the present invention, there is provided a reaction apparatus, comprising a reaction container to receive a supply of a reactant and to cause a reaction of the reactant supplied thereto and a heat-insulating container to house the reaction container, the heat-insulating container having an inner space of which a pressure is set lower than an atmospheric pressure, wherein the reaction container comprises a hollow box member composed by having a first plate wherein a supplying passage of the reactant is formed, a second plate opposite to the first plate, and a third plate provided continuously with an edge of the first plate and an edge of the second plate and at least one partition plate which is disposed to partition a space inside the box member and to form a reaction passage through which the reactant flows, and are joined to an inner surface of the second plate.

In order to obtain the advantage described above, according to a third aspect of the present invention, there is provided a reaction apparatus, comprising a reaction container to receive a supply of a reactant and to cause a reaction of the reactant supplied thereto, wherein the reaction container comprises a hollow box member composed by having a first plate wherein a supplying passage of the reactant is formed, a second plate opposite to the first plate, and a third plate provided continuously with an edge of the first plate and an edge of the second plate, at least one partition plates which is disposed to partition a space inside the box member and to form a reaction passage through which the reactant flows, the partition plate including a diaphragm portions provided substantially in a perpendicular direction to the second plate and a joint portion provided at an end of the diaphragm portion substantially perpendicularly to the diaphragm portion, and the joint portion being joined to an inner surface of the second plate.

### BRIEF DESCRIPTION OF THE DRAWING

FIG. 1 is a side view of a micro reactor module as an embodiment of a reaction apparatus according to the present invention.

FIG. 2 is a schematic side view of the micro reactor module in this embodiment when functions thereof are classified.

FIG. 3 is an exploded perspective view of the micro reactor module in this embodiment when viewed from obliquely above.

FIG. 4 is an arrow cross-sectional view of a plane along a cutting plane line IV-IV of FIG. 1.

FIG. 5 is an arrow cross-sectional view of a plane along a cutting plane line V-V of FIG. 1.

FIG. 6 is an exploded perspective view of a reformer in the micro reactor module of this embodiment when viewed from obliquely below.

FIG. 7 is an exploded perspective view of a carbon monoxide remover in the micro reactor module of this embodiment when viewed from obliquely below.

FIG. 8 is an arrow cross-sectional view of a plane along a cutting plane line VIII-VIII of FIG. 1.

FIG. 9 is a view showing a route from supply of combustion air/fuel mixtures formed of gas fuel and air to discharge of water and the like as products in the micro reactor module of this embodiment.

FIG. 10 is a view showing a route from the point where liquid fuel and water are supplied to the point where an air/fuel mixture, containing hydrogen gas as a product, is discharged in the micro reactor module of this embodiment.

FIG. 11 is an exploded perspective view of a heat-insulating package covering the micro reactor module of this embodiment when viewed from obliquely below.

FIG. 12 is a graph showing a result of calculating a relationship between a heat loss and a thickness of a vacuum layer in the micro reactor module of this embodiment.

FIG. 13 is a graph showing a result of calculating a relationship between a surface temperature of the heat-insulating package and the thickness of the vacuum layer in the micro reactor module of this embodiment.

FIG. 14 is a scatter diagram showing results of calculating amounts of deformation of the reaction container with respect to a thickness of a top plate of the reaction container in the micro reactor module of this embodiment.

FIG. 15 is a table showing results of calculating heat capacity ratios of the reaction container in the case of changing the thickness of the top plate of the reaction container in the micro reactor module of this embodiment.

FIG. 16 is a perspective view showing an example of a power generation unit including the micro reactor module in this embodiment.

FIG. 17 is a perspective view showing an example an electronic instrument using the power generation unit as a power source.

FIG. 18 is an exploded perspective view showing a carbon monoxide remover in a first modification example of the micro reactor module of the present invention.

FIGS. 19A and 19B are a plan view and side view of the carbon monoxide remover in the first modification example.

FIG. 20 is an arrow cross-sectional view of a plane along a cutting plane line XX-XX of FIG. 19B.

FIG. 21 is an arrow cross-sectional view of a plane along a cutting plane line XXI-XXI of FIG. 19B.

FIG. 22 is an exploded perspective view of a partition member for use in the carbon monoxide remover in the first modification example.

FIG. 23 is a cross-sectional view showing a configuration of a base plate corresponding to the carbon monoxide remover in the first modification example.

FIG. 24 is a schematic cross-sectional view showing relationships among the respective reaction chambers, an introduction port, a discharge port, and connection ports in the carbon monoxide remover of the first modification example.

FIG. 25 is an exploded perspective view showing a carbon monoxide remover in a second modification example of the micro reactor module of the present invention.

FIGS. 26A and 26B are a plan view and side view of the carbon monoxide remover in the second modification example.

FIG. 27 is an arrow cross-sectional view of a plane along a cutting plane line XXVII-XXVII of FIG. 26B.

FIG. 28 is an arrow cross-sectional view of a plane along a cutting plane line XXVIII-XXVIII of FIG. 26B.

FIG. 29 is an exploded perspective view of a partition member for use in the carbon monoxide remover in the second modification example.

FIG. 30 is an exploded perspective view of a carbon monoxide remover in a third modification example of the micro reactor module of the present invention.

FIGS. 31A and 31B are a plan view and side view of the carbon monoxide remover in the third modification example.

FIG. 32 is an arrow end view of a plane along a cutting plane line XXXII-XXXII of FIG. 31B.

FIG. 33 is an arrow end view of a plane along a cutting plane line XXXIII-XXXIII of FIG. 31B.

### DETAILED DESCRIPTION OF THE PREFERRED EMBODIMENTS

A description will be made below of details of a reaction apparatus according to the present invention based on embodiments shown in the drawings. However, though a variety of limitations which are technically preferable are imposed on the embodiments which are to be described below in order to carry out the present invention, the scope of the invention is not limited to the following embodiments and illustrated drawings.

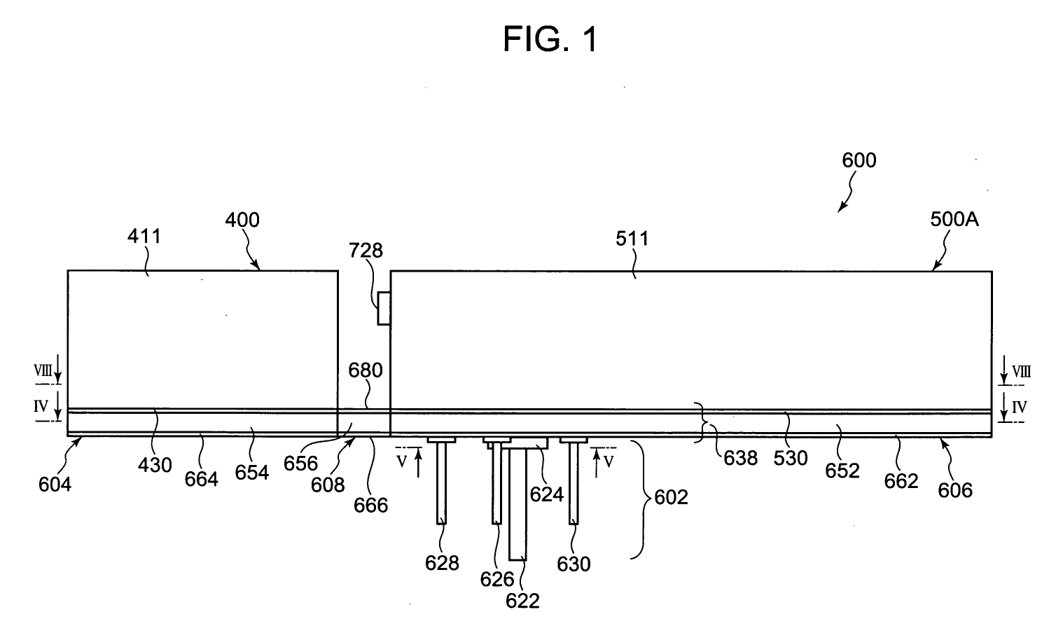

FIG. 1 is a side view of a micro reactor module as an embodiment of the reaction apparatus according to the present invention.

This micro reactor module 600 is built in an electronic instrument such as, for example, a notebook personal computer, a PDA, an electronic organizer, a digital camera, a cellular phone, a register, and a projector, and generates hydrogen gas for use in a fuel cell.

As shown in FIG. 1, the micro reactor module 600 in this embodiment includes a supply/discharge portion 602 in which a reactant is supplied and a product is discharged, a high-temperature reaction portion 604 set at a relatively high temperature and causing a reforming reaction, and a low-temperature reaction portion 606 set at a lower temperature than the set temperature of the high-temperature reaction portion 604 and causing a selective oxidation reaction, and a coupling portion 608 that transfers the reactant and the product between the high-temperature reaction portion 604 and the low-temperature reaction portion 606.

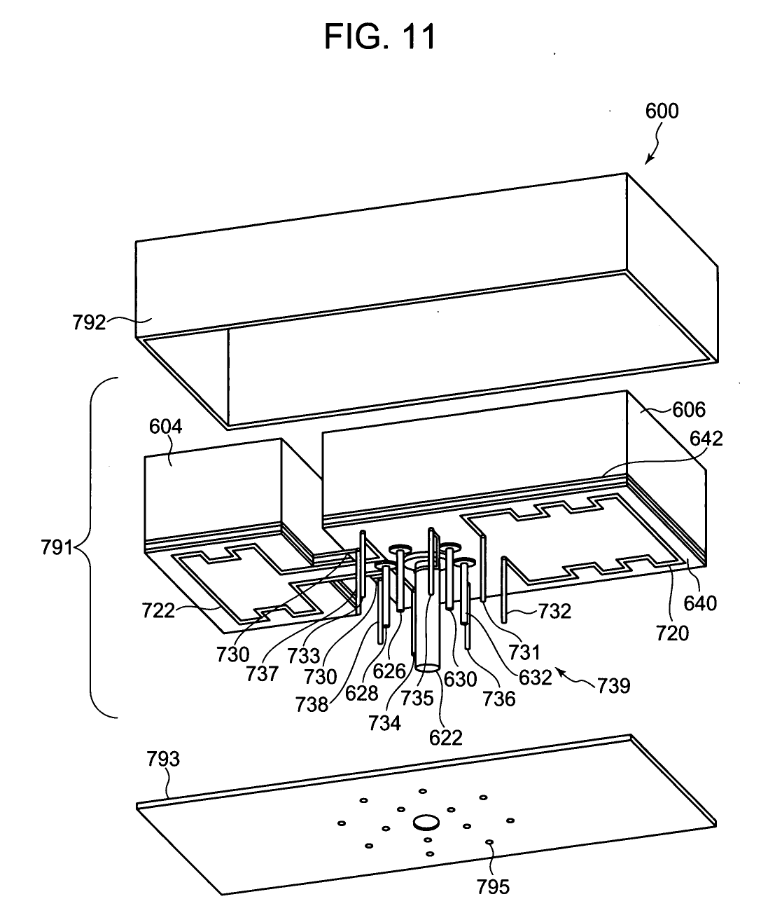

Note that, as shown in FIG. 11 to be described later, the micro reactor module 600 is housed in a heat-insulating package 791 of which inner pressure is reduced.

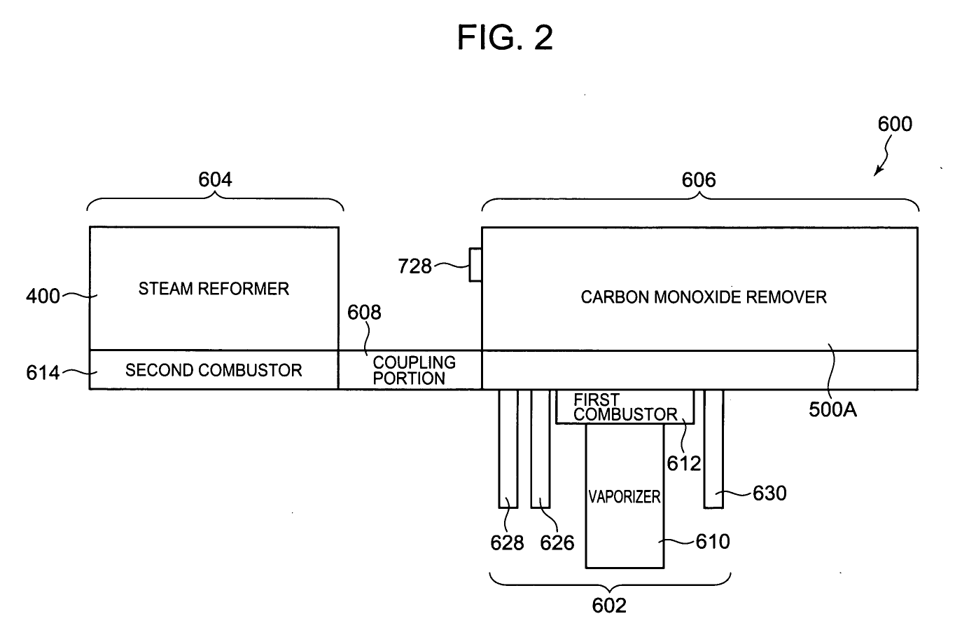

FIG. 2 is a schematic side view of the micro reactor module in this embodiment when functions thereof are classified.

In the supply/discharge portion 602, the reactant is supplied from an outside of the heat-insulating package to the micro reactor module 600, and the product is discharged from the micro reactor module 600 to the outside of the heat-insulating package 791.

As shown in FIG. 2, in the supply/discharge portion 602, a vaporizer 610 and a first combustor 612 are provided. To the first combustor 612, air and gas fuel (for example, hydrogen gas, methanol, or the like) are supplied separately from each other or as an air-fuel mixture, and heat is generated by catalytic combustion of these. To the vaporizer 610, water and liquid fuel (for example, methanol, ethanol, dimethyl ether, butane, or gasoline) are supplied from a fuel container separately from each other or in a state of mixed together. Then, the water and the fuel are vaporized in the vaporizer 610 by the combustion heat in the first combustor 612.

In the high-temperature reaction portion 604, there are mainly provided a second combustor 614 and a reformer 400 provided on the second combustor 614.

To the second combustor 614, air and gas fuel (for example, hydrogen gas, methanol gas, or the like) are supplied separately from each other or as an air-fuel mixture, and heat is generated by catalytic combustion of these. Note that, while electricity is generated by an electrochemical reaction of the hydrogen gas in the fuel cell, unreacted hydrogen gas contained in off-gas discharged from the fuel cell may be supplied to the first combustor 612 and the second combustor 614 in a state of being mixed with the air. As a matter of course, a configuration may be adopted, in which liquid fuel (for example, methanol, ethanol, dimethyl ether, butane, or gasoline) reserved in the fuel container is vaporized by another vaporizer, and an air/fuel mixture of the vaporized fuel and the air is supplied to the first combustor 612 and the second combustor 614.

To the reformer 400, the air/fuel mixture (first reactant) formed by vaporizing the water and the liquid fuel is supplied from the vaporizer 610, and is heated by the second combustor 614. In the reformer 400, hydrogen gas and the like (first product) are generated from steam and the vaporized liquid fuel by a catalytic reaction, and further, carbon monoxide gas is generated though an amount thereof is trace. When the fuel is methanol, chemical reactions as in the following Formulas (1) and (2) occur. Note that the reaction in which hydrogen is generated is an endothermic reaction, for which the combustion heat is used.

CH₃OH+H₂O→3H₂+CO₂ (1)

2CH₃OH+H₂O→5H₂+CO+CO₂ (2)

In the low-temperature reaction portion 606, a carbon monoxide remover 500A is mainly provided. To the carbon monoxide remover 500A, an air/fuel mixture (second reactant) heated by the first combustor 612 and containing the hydrogen gas and the trace amount of carbon monoxide gas and the like generated by the chemical reaction of the above-described Formula (2) is supplied from the reformer 400, and further, air is supplied. In the carbon monoxide remover 500A, carbon monoxide in the air/fuel mixture is selectively oxidized, and carbon monoxide is thereby removed. The air/fuel mixture (second product: hydrogen-enriched gas) in a state where carbon monoxide is removed therefrom is supplied to a fuel electrode of the fuel cell.

An outer shape of the coupling portion 608 is formed, for example, into a prism shape. A width of the coupling portion 608 is narrower than a width of the high-temperature reaction portion 604 and the low-temperature reaction portion 606, and a height of the coupling portion 608 is also lower than heights of the high-temperature reaction portion 604 and the low-temperature reaction portion 606. Therefore, the coupling portion 608 can maintain a difference between an appropriate temperature of the high-temperature reaction portion 604 and an appropriate temperature of the low-temperature reaction portion 606, further can suppress a heat loss of the high-temperature reaction portion 604, and can suppress a temperature rise of the low-temperature reaction portion 606 to a set temperature or more. Moreover, while the coupling portion 608 is bridged between the high-temperature reaction portion 604 and the low-temperature reaction portion 606, the coupling portion 608 is coupled to the high-temperature reaction portion 604 at a crosswise center portion thereof, and to the low-temperature reaction portion 606 at a crosswise center portion thereof. Therefore, a stress applied to the coupling portion 608 based on a thermal expansion difference caused by the difference between the appropriate temperature of the high-temperature reaction portion 604 and the low-temperature reaction portion 606 is suppressed to the minimum, thus making it possible to prevent the fluid from leaking from the coupling portion 608.

### [Specific Configuration of Microreactor Module]

Next, a description will be made of an example of a specific configuration of the microreactor module 600.

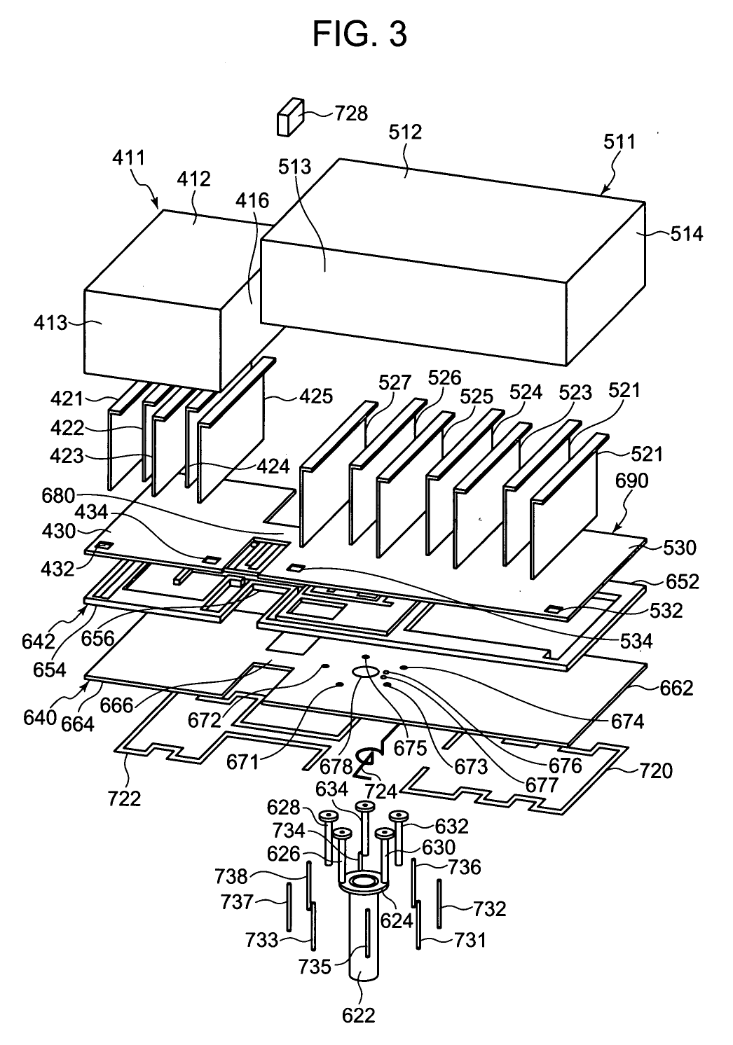

FIG. 3 is an exploded perspective view of the microreactor module in this embodiment when viewed from obliquely above.

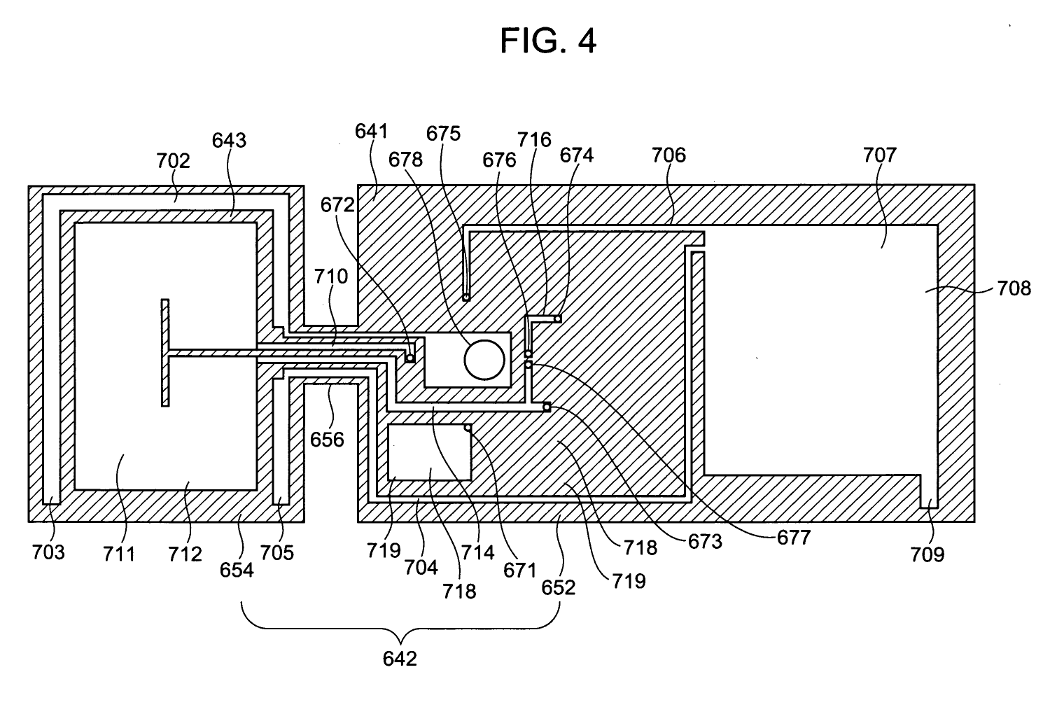

FIG. 4 is an arrow cross-sectional view of a plane along a cutting plane line IV-IV of FIG. 1.

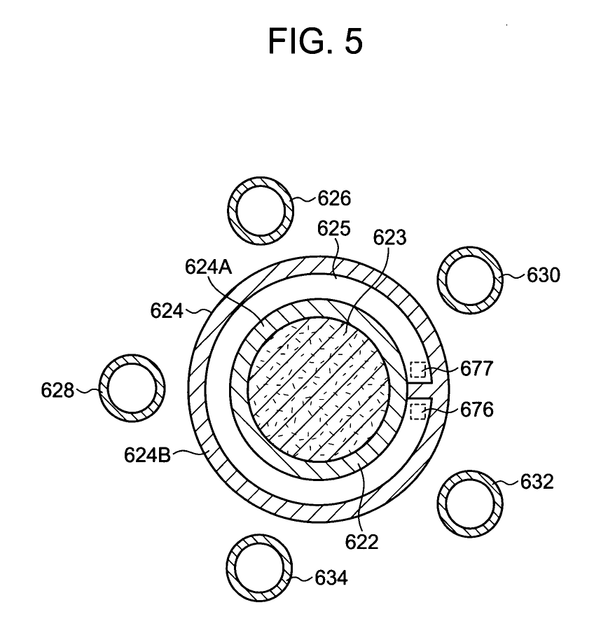

FIG. 5 is an arrow cross-sectional view of a plane along a cutting plane line V-V of FIG. 1.

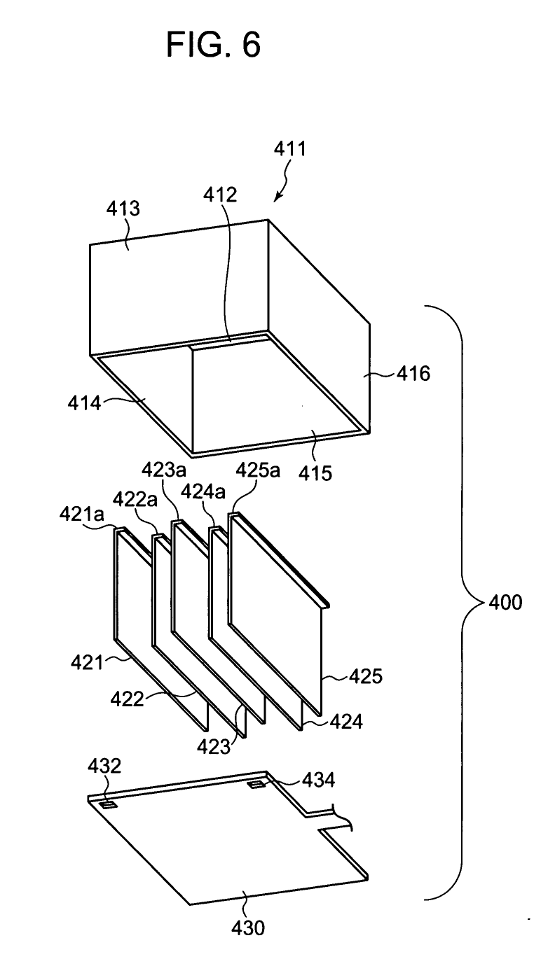

FIG. 6 is an exploded perspective view of the reformer in the microreactor module of this embodiment when viewed from obliquely below.

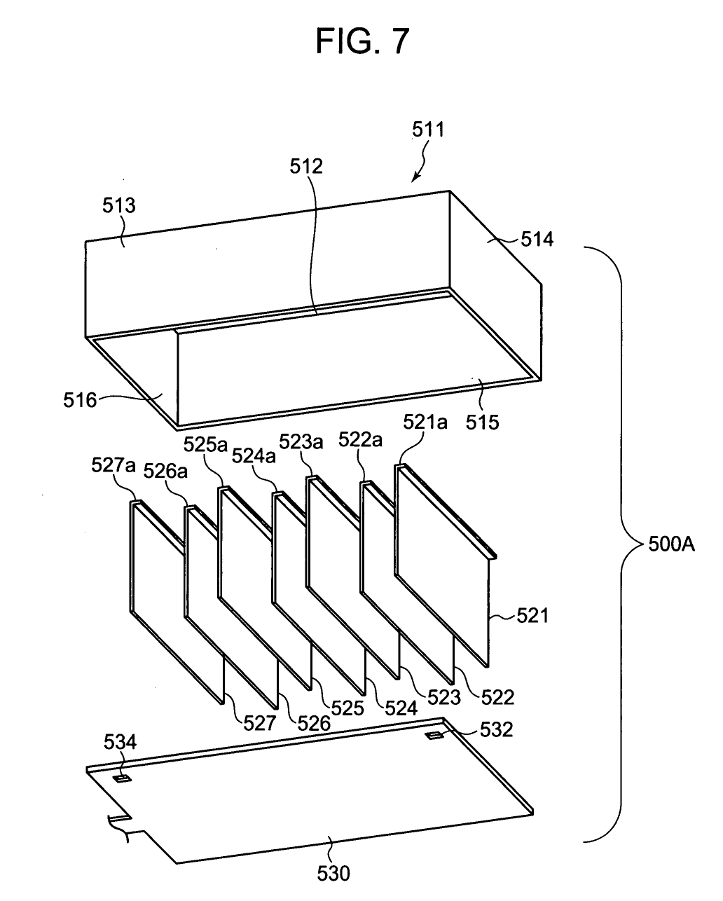

FIG. 7 is an exploded perspective view of the carbon monoxide remover in the microreactor module of this embodiment when viewed from obliquely below.

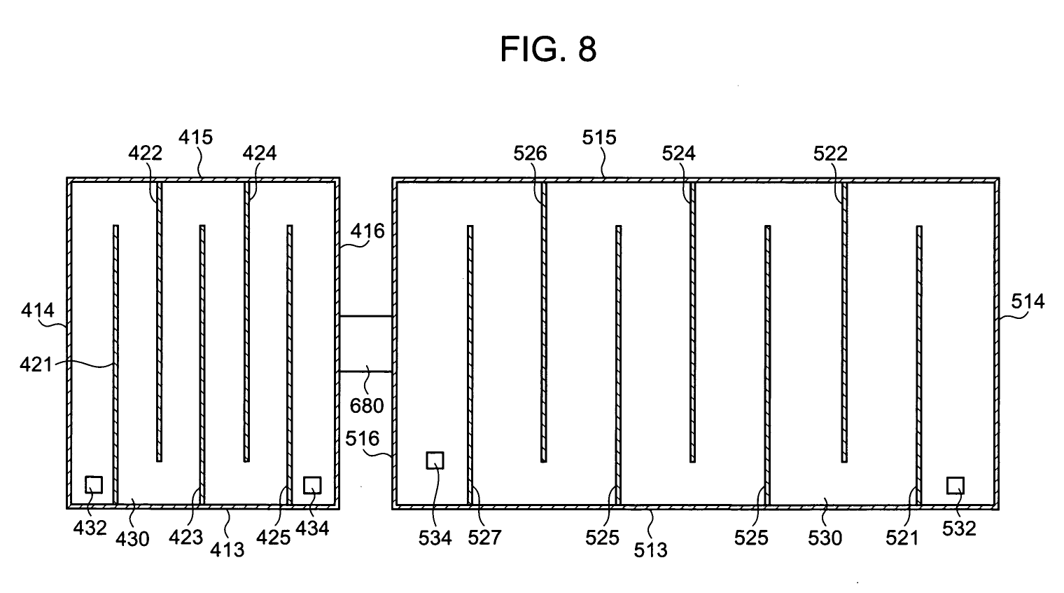

FIG. 8 is an arrow cross-sectional view of a plane along a cutting plane line VIII-VIII of FIG. 1.

### [Base Portion]

As shown in FIG. 1 and FIG. 3, a base portion 638 is composed by stacking a base plate 642, an insulating plate 640, and a plate member 690, and serves a base common to the high-temperature reaction portion 604, the low-temperature reaction portion 606, and the coupling portion 608. The insulating plate 640 is provided on one surface of the base plate 642, and the plate member 690 is provided on the other surface. The base portion 638 is composed so as to be hardly deformed even if the microreactor module 600 is housed as will be described later in the heat-insulating package 791 of which inner pressure is reduced in such a manner that sufficient strength can be obtained by sufficiently thickening the base plate 642 and by a stack structure of the base portion 638 concerned.

The insulating plate 640 is provided on one surface of the base plate 642, and is composed of a base portion 662 serving as a base of the low-temperature reaction portion 606, a base portion 664 serving as a base of the high-temperature reaction portion 604, and a coupling base portion 666 serving as a base of the coupling portion 608.

The insulating plate 640 is a plate obtained by integrally forming the base portion 662, the base portion 664, and the coupling base portion 666, and is formed into a shape constricted at the coupling base portion 666. This insulating plate 640 is formed of an electric insulator such as, for example, ceramics.

As shown in FIG. 3 and FIG. 4, in a state where the insulating plate 640 is joined to the base plate 642, through holes 671 to 678 penetrate through the base portion 652 of the base plate 642 and the base portion 662 of the insulating plate 640.

As shown in FIG. 1, FIG. 3, and FIG. 5, on a lower surface of the base portion 662, there are provided a liquid fuel introduction pipe 622 and a combustor plate 624, which will be described later, and five pipe members 626, 628, 630, 632 and 634 arrayed around the liquid fuel introduction pipe 622 and the combustor plate 624.

The liquid fuel introduction pipe 622, the combustor plate 624, and the pipe members 626, 628, 630; 632 and 634 form the supply/discharge portion 602.

The pipe members 626, 628, 630, 632 and 634 are joined to the lower surface of the base portion 662 by flange portions thereof. Here, the pipe member 626 communicates with the through hole 671, the pipe member 628 communicates with the through hole 672, the pipe member 630 communicates with the through hole 673, the pipe member 632 communicates with the through hole 674, and the pipe member 634 communicates with the through hole 675.

The plate member 690 is formed of a metal plate, for example, of stainless steel or the like. The plate member 690 is joined to a surface of the base plate 642, which is opposite with the insulating plate 640, by welding or brazing. The plate member 690 is reinforced by being joined to the base plate 642. Accordingly, even if the plate member 690 is housed in the heat-insulating package 791 of which inner pressure is reduced, deformation of the plate member 690 can be prevented.

The plate member 690 is obtained by integrally forming a bottom plate 430 serving as a part of the reformer 400, a bottom plate 530 serving as a part of the carbon monoxide remover 500A, and a coupling cap 680 in a state where the bottom plate 430 and the bottom plate 530 are coupled to each other by the coupling cap 680, and is formed into a shape constricted at the coupling cap 680.

The base plate 642 is formed of a plate-like metal material such as, for example, stainless steel, and includes the base portion 652 serving as a base of the low-temperature reaction portion 606, a base portion 654 serving as the base of the high-temperature reaction portion 604, and a coupling base portion 656 serving as the base of the coupling portion 608.

The base plate 642 is a plate obtained by integrally forming the base portion 652, the base portion 654, and the coupling base portion 656, and is formed into a shape constricted at the coupling base portion 656.

As shown in FIG. 4, on the surface of the base plate 642, on which the plate member 690 is provided, a stage 641 and a stage 643 which are made one step higher than grooves are provided on the base portion 652 and the base portion 654, respectively, where the grooves serve as a reformed fuel supply passage 702, a communication passage 704, an air supply passage 706, a mixing chamber 708, a combustion fuel supply passage 710, a combustion chamber 712 serving as the second combustor 614, an exhaust gas passage 714, a combustion fuel supply passage 716, and a discharge chamber 718.

The reformed fuel supply passage 702, the communication passage 704, the air supply passage 706, the mixing chamber 708, the combustion fuel supply passage 710, the combustion chamber 712, the exhaust gas passage 714, the combustion fuel supply passage 716, and the discharge chamber 718 are covered in such a manner that the plate member 690 is joined to the base plate 642.

The reformed fuel supply passage 702 is formed so as to reach a corner of the base portion 654 of the high-temperature reaction portion 604 from the through hole 678 of the low-temperature reaction portion 606 through the coupling base portion 656 of the coupling portion 608. The mixing chamber 708 is formed of a quadrangular bottom surface 707 in the base portion 652 of the low-temperature reaction portion 606. The communication passage 704 is formed so as to reach the mixing chamber 708 from a corner of the base portion 654 of the high-temperature reaction portion 604 through the coupling base portion 656. The air supply passage 706 is formed so as to reach the mixing chamber 708 from the through hole 675 of the low-temperature reaction portion 606.

### [Second Combustor]

As shown in FIG. 4, the combustion chamber 712 is formed of a C-like bottom surface 711 on a center of the base portion 654. A combustion catalyst for burning the air/fuel mixture to be burned is supported on a wall surface of the combustion chamber 712, which includes a lower surface of the plate member 690 and an upper surface of the bottom plate 711. For example, platinum is mentioned as the combustion catalyst. This combustion chamber 712 corresponds to the second combustor 614.

The combustion fuel supply passage 710 is formed so as to reach the combustion chamber 7122 from the through hole 672 through the coupling base portion 656. The exhaust gas passage 714 is formed so as to reach the through hole 673 from the through hole 677, and is formed so as to reach the through hole 673 from the combustion chamber 712 through the coupling base portion 656. The combustion fuel supply passage 716 is formed so as to reach the through hole 676 from the through hole 674 in the base portion 652. The discharge chamber 718 is formed as a rectangular recessed portion a little lower than the stage 641 in the base portion 652, in which the through hole 671 communicates with a corner of the discharge chamber 718.

### [Vaporizer]

As shown in FIG. 3, FIG. 4, and FIG. 5, the liquid fuel introduction pipe 622 communicates with the through hole 678, and is joined to the lower surface of the base portion 662 by a flange portion thereof. The liquid fuel introduction pipe 622 corresponds to the vaporizer 610, into an inside of which a liquid-absorbent material 623 is filled. The liquid-absorbent material 623 may be one formed by binding inorganic or organic fiber with a binder, one formed by sintering inorganic fiber, one formed by binding the inorganic powder with the binder, or a mixture of graphite and glassy carbon. Specifically, a felt material, a porous ceramic material, a fiber material, a porous carbon material, and the like are used as the liquid-absorbent material 623.

### [First Combustor]

As shown in FIG. 3, FIG. 4, and FIG. 5, the combustor plate 624 is provided so as to surround the liquid fuel introduction pipe 622 at an upper end of the liquid fuel introduction pipe 622, and is joined to a lower surface of the low-temperature reaction portion 606. One end of a combustion passage 625 of the combustor plate 624 communicates with the through hole 676, and the other end of the combustion passage 625 communicates with the through hole 677. The combustor plate 624 is joined to the liquid fuel introduction pipe 622 and the low-temperature reaction portion 606, for example, by brazing. As a brazing material, the following wax is particularly preferable. The particularly preferable wax should have a melting point higher than the highest temperature among temperatures of the fluids flowing through the liquid fuel introduction pipe 622 and on the combustor plate 624. Preferably, the melting point is 700° C. or more. The particularly preferable wax is gold wax in which silver, copper, zinc, or cadmium is contained in gold, wax mainly containing gold, silver, zinc, or nickel, or wax mainly containing gold, palladium, or silver. The combustor plate 624 also functions as the flange for joining the liquid fuel introduction pipe 622 to the low-temperature reaction portion 606.

A through hole 624A is formed on a center of the combustor plate 624, the liquid fuel introduction pipe 622 is fitted into the through hole 624A, and the liquid fuel introduction pipe 622 and the combustor plate 624 are thereby joined to each other.

Moreover, on one surface of the combustor plate 624, a partition wall 624B is provided so as to protrude therefrom. A part of the partition wall 624B is provided over the entire circumference of an outer edge of the combustor plate 624, and the other part is provided in a diameter direction. The combustor plate 624 is joined to the lower surface of the low-temperature reaction portion 606, whereby the combustion passage 625 is formed on a joined surface of both thereof, and the liquid fuel introduction pipe 622 is surrounded by the combustion passage 625. The combustion catalyst for burning the air/fuel mixture to be burned is supported on a wall surface of the combustion passage 625. For example, platinum is mentioned as the combustion catalyst. Note that the liquid-absorbent material 623 in the liquid fuel introduction pipe 622 is filled up to a position of the combustor plate 624. This combustion passage 625 corresponds to the first combustor 612.

### [Heating Wire]

As shown in FIG. 3, a heating wire 720 is patterned in a meandering state on the lower surface of the low-temperature reaction portion 606, that is, on a lower surface of the insulating plate 640.

On the lower surface, a heating wire 722 is patterned in a meandering state from the low-temperature reaction portion 606 through the coupling portion 608 to the high-temperature reaction portion 604.

A heating wire 724 is patterned from the lower surface of the low-temperature reaction portion 606 through the surface of the combustor plate 624 to a side surface of the liquid fuel introduction pipe 622.

Here, an insulating film of silicon nitride, silicon oxide, or the like is formed on the side surface of the liquid fuel introduction pipe 622 and the surface of the combustor plate 624, and the heating wire 724 is formed on a surface of the insulating film.

The heating wires 720, 722 and 724 are patterned on the insulating film or the insulating plate 640, whereby a voltage to be applied is supplied to the heating wires 720, 722 and 724 without being hardly applied to the base plate 642, the liquid fuel introduction pipe 622, the combustor plate 624, and the like, which are made of the metal material. Accordingly, heat generation efficiency of the heating wires 720, 722 and 724 can be enhanced.

Each of the heating wires 720, 722 and 724 is a wire formed by sequentially stacking an adhesion layer, a diffusion prevention layer, and a heat generation layer from the insulating plate 640 side.

The heating layer is made of a material (for example, Au) of which resistivity is the lowest among those of the three layers. When the voltage is applied to each of the heating wires 720, 722 and 724, a current flows concentratedly to the heat generation layer, and the heating layer generates heat.

For the diffusion prevention layer, it is preferable to use a substance in which a melting point is relatively high and reactivity is relatively low (for example, W) so that the material of the heat generation layer cannot be diffused into the diffusion prevention layer and the adhesion layer.

The adhesive layer is a layer for use when the diffusion prevention layer is not excellent in adhesion with the insulating plate 640. The adhesive layer is made of a material excellent in adhesion with both of the diffusion prevention layer and the insulating plate 640 (for example, Ta, Mo, Ti, Cr).

The heating wire 720 heats up the low-temperature reaction portion 606 at the time of activation, the heating wire 722 heats up the high-temperature reaction portion 604 and the coupling portion 608 at the time of activation, and the heating wire 724 heats up the vaporizer 502 and the first combustor 612.

Thereafter, the off-gas containing hydrogen left without being used for the electrochemical reaction is discharged from the fuel cell for generating power by the hydrogen gas discharged from the microreactor module 600. After this off-gas is introduced into the second combustor 614 and burned there, the heating wire 722 heats up the high-temperature reaction portion 604 and the coupling portion 608 while functioning as an auxiliary of the second combustor 614. In a similar way, when the off-gas containing hydrogen from the fuel cell is burned in the first combustor 612, the heating wire 720 and the heating wire 724 heat up the low-temperature reaction portion 606 while functioning as auxiliaries of the first combustor 612.

Moreover, since electric resistances of the heating wires 720, 722 and 724 are varied in response to changes of temperatures thereof, the heating wires 720, 722 and 724 also function as temperature sensors capable of reading the temperatures from resistance values to predetermined applied voltage or current. Specifically, the temperatures of the heating wires 720, 722 and 724 are proportional to the electric resistances thereof.

Any ends of the heating wires 720, 722 and 724 are located on the lower surface of the low-temperature reaction portion 606, and these ends are arrayed so as to surround the combustor plate 624.

Lead wires 731 are 732 are connected to both ends of the heating wire 720, lead wires 733 and 734 are connected to both ends of the heating wire 722, and lead wires 735 and 736 are connected to both ends of the lead wires 724. Note that, in FIG. 1, illustrations of the heating wires 720, 722 and 724 and the lead wires 731 to 736 are omitted for the purpose of making it easy to see the drawing.

### [Reformer]

The reformer 400 is provided on the base portion 654.

As shown in FIG. 6 and FIG. 8, the reformer 400 is composed of a box body 411, five partition plates 421 to 425, and the bottom plate 430. The box body 411 and the partition plates 421 to 425 are made of metal plates, for example, of stainless steel or the like in a similar way to the bottom plate(first plate) 430.

The box body 411 includes a rectangular top plate(second plate) 412, a pair of side plates (side plate) 413 and 415 connected to two sides opposite to each other among four sides of the top plate 412 in a state of being perpendicularly continuous with the top plate 412, and a pair of side plates 414 and 416 connected to other two sides of the top plate 412, which are opposite to each other, in a state of being perpendicularly continuous with the top plate 412. The side plates 413 and 415 are connected to the side plates 414 and 416 in a state of being perpendicularly continuous therewith, and these four side plates 413 to 416 form a square or rectangular frame shape.

The thicker the thicknesses of the top plate 412 and the side plates 413 to 416 are, the higher the strengths thereof become. Then, the top plate 412 and the side plates 413 to 416 can be prevented from being deformed in the case of being housed in the heat-insulating package 791 of which inner pressure is reduced. However, as the thicknesses get thicker, weight and heat capacity of the reformer 400 are increased, and for example, it takes longer to heat up the reformer 400 to a desired temperature at the time of activation.

Accordingly, in this embodiment, the box body 411 is reinforced by joining the partition plates 421 to 425 to the top plate 421 as will be described later. In such a way, the thicknesses of the top plate 412 and the side plates 413 to 416 can be thinned while maintaining the strength of the box body 411, whereby the weight and the heat capacity of the reformer 400 can be reduced, and the activation can be accelerated.

The partition plates 421 to 425 are provided to be spaced at an interval in parallel to the side plates 414 and 416. Ends of the partition plates 421, 423 and 425 on the side wall 413 side contact the side wall 413, and ends thereof on the side wall 415 side are arranged to be spaced apart from the side wall 415.

Further, ends of the partition plates 422 and 424 on the side wall 415 side contact the side wall 415, and ends thereof on the side wall 413 side are arranged to be spaced apart from the side wall 413.

On upper ends of the partition plates 421 to 425, joint portions 421a to 425a parallel to the top plate 412 are provided. The joint portions 421a to 425a are joined to the top plate 412 by welding or brazing, and the partition plates 421 to 425 are thereby fixed to an inside of the box body 411.

The top plate 412 and the partition plates 421 to 425 are joined to each other as described above, whereby the top plate 412 can be reinforced in comparison with the case where the top plate 412 and the partition plates 421 to 425 are not joined to each other. In such a way, as will be described later, when the microreactor module 600 is housed in the heat-insulating package 791 of which inner pressure is reduced, the top plate 412 can be made hardly deformable even if the thickness of the top plate 412 is thinned to an extent to which the top plate 412 is largely deformed in the case of such a structure where the plate 412 and the partition plates 421 to 425 are not joined to each other.

The ends of the partition plates 422 and 424 on the side wall 415 side contact the side wall 415, and the ends thereof on the side wall 413 side are arranged to be spaced apart from the sidewall 413. Therefore, an inside of the reformer 400 is partitioned by the partition plates 421 to 425, and thereby becomes a serpentine passage continuous from an introduction port 432 to a discharge port 434. Moreover, the ends of the partition plates 421, 423 and 425, which contact the side wall 413, may be joined to the side wall 413, and the ends of the partition plates 422 and 424, which contact the side wall 415, may be joined to the side wall 415.

Lower ends of the partition plates 421 to 425 contact the bottom plate 430. Moreover, the lower ends of the partition plates 421 to 425 may be further joined to the bottom plate 430.

In a state where the bottom plate 430 contacts the lower ends of the partition plates 421 to 425, an edge of the bottom plate 430 is joined to lower sides of the side plates 413 to 416. A lower surface opening of the box body 411 is closed by the bottom plate 430 as described above, and a hollow box member is thereby formed. Then, the tetrahedral reformer 400 having the serpentine passage inside of the hollow box member is formed.

On ends of the bottom plate 430 on the side plate 413 side, there are provided the introduction port 432 for introducing the reactant into the reformer 400, and the discharge port 434 for discharging the product to the outside of the reformer 400. Note that the introduction port 432 is provided between the side plate 414 and the partition plate 421 to be described later, and the discharge port 434 is provided between the side plate 415 and the partition plate 425 to be described later.

As shown in FIG. 1 and FIG. 3, the bottom plate 430 is joined to the stage 643 located on an upper surface of the base portion 654. By the bottom plate 430, a part of the reformed fuel supply passage 702, a part of the exhaust gas passage 714, a part of the combustion fuel supply passage 710, a part of the communication passage 704, and the combustion chamber 712 are closed. The introduction port 432 formed in the bottom plate 430 is located above an end 703 of the reformed fuel supply passage 702, and the discharge port 434 formed in the bottom plate 430 is located above an end 705 of the communication passage 704.

As described above, the partition plates 421 to 425 are joined to the top plate 412 of the box body 411, and accordingly, a hollow space formed of the box body 411 and the bottom plate 420 becomes the serpentine passage continuous from the introduction port 432 to the discharge port 434 by the partition plates 421 to 425.

In this reformer 400, a reforming catalyst (for example, Cu/ZnO catalyst and Pd/ZnO catalyst) is supported on inner surfaces of the box body 411 and the bottom plate 430 and surfaces of the partition plates 421 to 425.

In order to assemble the reformer 400, the partition plates 421 to 425 are first joined to the inside of the box body 411. Subsequently, the reforming catalyst is supported on the inner surface of the box body 411, the surfaces of the partition plates 421 to 425, and an upper surface of the bottom plate 430. Thereafter, lower ends of the side walls 413 to 416 of the box body 411 and the outer edge of the bottom plate 430 are joined to each other, and the lower opening of the box body 411 is closed by the bottom plate 430.

### [Carbon Monoxide Remover]

The carbon monoxide remover 500A is provided on the base portion 652.

As shown in FIG. 7 and FIG. 8, this carbon monoxide remover 500A is composed of a box body 511, seven partition plates 521 to 527, and a bottom plate (first plate) 530. The box body 511 and the partition plates 521 to 527 are formed of metal plates, for example, of stainless steel or the like in a similar way to the bottom plate 530.

The box body 511 includes a rectangular top plate(second plate) 512, a pair of side plates(third plate) 513 and 515 connected to two sides opposite to each other among four sides of the top plate 512 in a state of being perpendicularly continuous with the top plate 512, and a pair of side plates 514 and 516 connected to other two sides of the top plate 512, which are opposite to each other, in a state of being perpendicularly continuous with the top plate 512. The side plates 513 and 515 are connected to the side plates 514 and 516 in a state of being perpendicularly continuous therewith, and these four side plates 513 to 516 form a square or rectangular frame shape.

The thicker the thicknesses of the top plate 512 and the side plates 513 to 516 are, the higher the strengths thereof become. Then, the top plate 512 and the side plates 513 to 516 can be prevented from being deformed in the case of being housed in the heat-insulating package 791 of which inner pressure is reduced. However, in a similar way to the above-described reformer,

as the thicknesses are being thicker, weight and heat capacity of the carbon monoxide remover 500A are increased, and for example, it takes longer to heat up the carbon monoxide remover 500A to a desired temperature at the time of activation. Therefore, in this embodiment, as will be described later, the box body 511 is reinforced by joining the partition plates 521 to 527 to the top plate 512 in a similar way to the case of the above-described reformer 400. In such a way, the thicknesses of the top plate 512 and the side plates 513 to 516 can be thinned while maintaining the strength of the box body 511, whereby the weight and the heat capacity of the carbon monoxide remover 500A can be reduced, and the activation can be accelerated.

The partition plates 521 to 527 are provided to be spaced at an interval in parallel to the side plates 514 and 516. Ends of the partition plates 521, 523, 525, and 527 on the side wall 513 side contact the side wall 513, and ends thereof on the side wall 515 side are arranged to be spaced apart from the side wall 515.

On upper ends of the partition plates 521 to 527, joint portions 521a to 527a parallel to the top plate 512 are provided. The joint portions 521a to 527a are joined to the top plate 512 by welding or brazing, and the partition plates 521 to 527 are thereby fixed to an inside of the box body 511.

The top plate 512 and the partition plates 521 to 527 are joined to each other as described above, whereby the top plate 512 can be reinforced in comparison with the case where the top plate 512 and the partition plates 521 to 527 are not joined to each other. In such a way, as will be described later, when the microreactor module 600 is housed in the heat-insulating package 791 of which inner pressure is reduced, the top plate 512 can be made hardly deformable even if the thicknesses of the top plate 512 and the side plates 521 to 527 are thinned to an extent to which the top plate 512 and the side plates 521 to 527 are largely deformed in the case of such a structure where the top plate 512 and the partition plates 521 to 527 are not joined to each other.

The ends of the partition plates 522, 524 and 526 on the side wall 515 side contact the side wall 515, and the ends thereof on the side wall 513 side are arranged to be spaced apart from the sidewall 513. Therefore, an inside of the carbon monoxide remover 500A is partitioned by the partition plates 521 to 527, and thereby becomes a serpentine passage continuous from an introduction port 532 to a discharge port 534.

Lower ends of the partition plates 521 to 527 contact the bottom plate 530. Moreover, the lower ends of the partition plates 521 to 527 may be further joined to the bottom plate 530.

On ends of the bottom plate 530 on the side plate 513 side, there are provided the introduction port 532 for introducing the reactant into the carbon monoxide remover 500A, and the discharge port 534 for discharging the product to the outside of the carbon monoxide remover 500A. Note that the introduction port 532 is provided between the side plate 514 and the partition plate 521, and the discharge port 534 is provided between the side plate 516 and the partition plate 527.

In a state where the bottom plate 530 contacts the lower ends of the partition plates 521 to 527, an edge of the bottom plate 530 is joined to lower sides of the side plates 513 to 516. A lower surface opening of the box body 511 is closed by the bottom plate 530 as described above, and a hollow box member is thereby formed. Then, the tetrahedral carbon monoxide remover 500A having the serpentine passage inside of the hollow box member is formed.

The bottom plate 530 is joined to an upper surface of the base portion 652. By the bottom plate 530, a part of the reformed fuel supply passage 702, a part of the exhaust gas passage 714, a part of the combustion fuel supply passage 710, a part of the communication passage 704, the air supply passage 706, the mixing chamber 708, the combustion fuel supply passage 716, and the discharge chamber 718 are closed. The introduction port 532 formed in the bottom plate 530 is located above a corner 709 of the mixing chamber 708, and the discharge port 534 formed in the bottom plate 530 is located above a corner 719 of the discharge chamber 718.

In this carbon monoxide remover 500A, a carbon monoxide selective oxidation catalyst (for example, platinum and the like) is supported on inner surfaces of the box body 511 and the bottom plate 530 and on the partition plates 521 to 527.

In order to assemble the carbon monoxide remover 500A, the partition plates 521 to 527 are first joined to the inside of the box body 511. Subsequently, the reforming catalyst is supported on the inner surface of the box body 511, the surfaces of the partition plates 521 to 527, and an upper surface of the bottom plate 530. Thereafter, lower ends of the side walls 513 to 516 of the box body 511 and the outer edge of the bottom plate 530 are joined to each other, and the lower opening of the box body 511 is closed by the bottom plate 530.

### [Route in Microreactor Module 600]

Next, a description will be made of the passages provided in the insides of the supply/discharge portion 602, the high-temperature reaction portion 604, the low-temperature reaction portion 606, and the coupling portion 608.

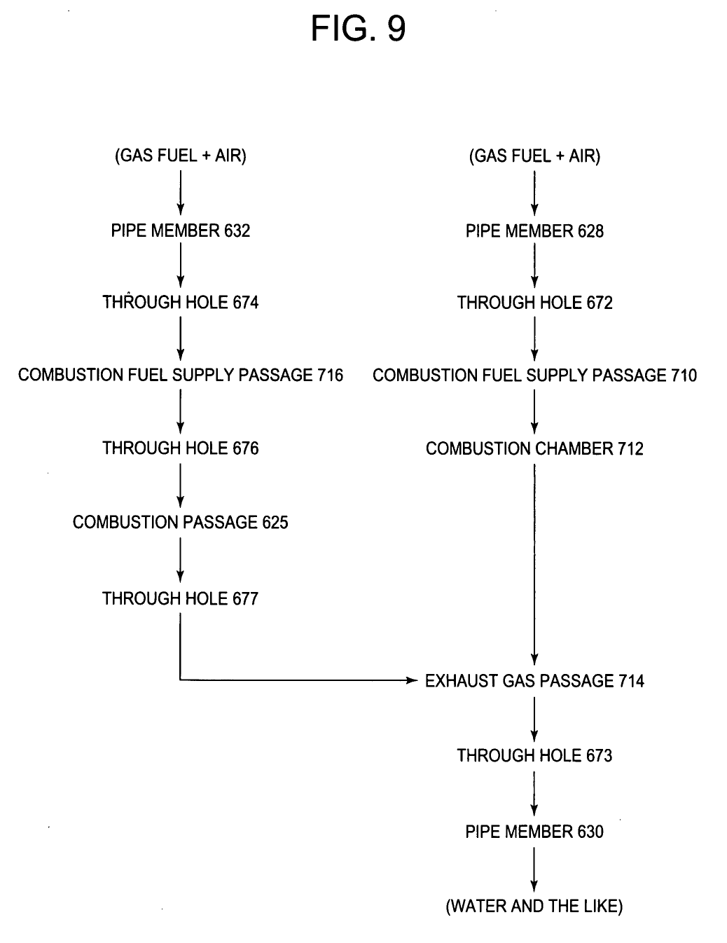

FIG. 9 is a view showing a route from the supply of combustion air/fuel mixtures formed of the gas fuel and the air to the discharge of steam and the like as the products in the microreactor module of this embodiment.

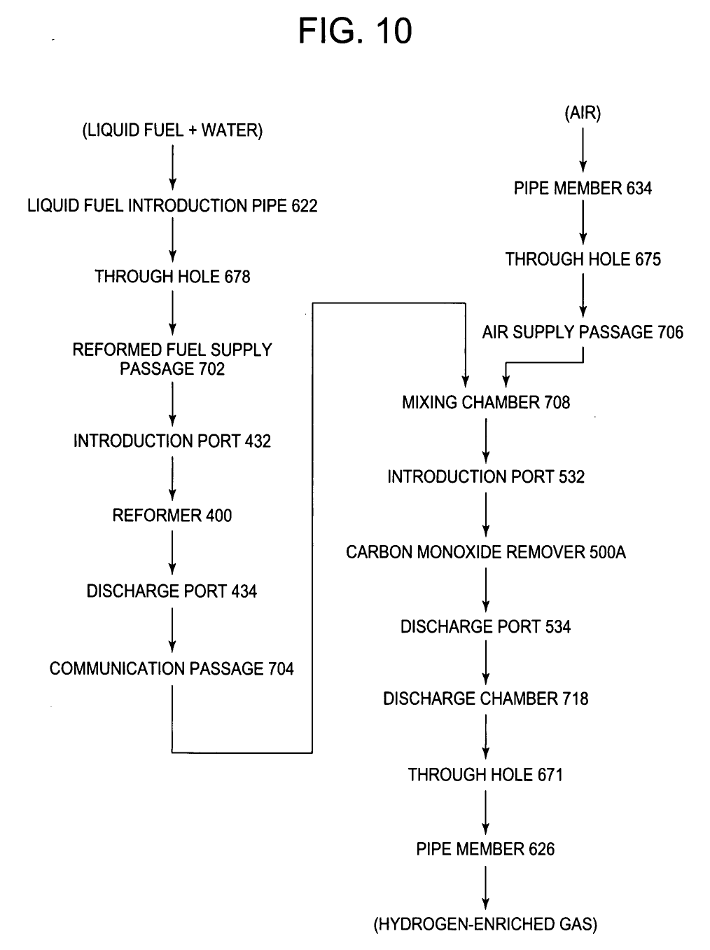

FIG. 10 is a view showing a route from the point where liquid fuel and water are supplied to the point where an air/fuel mixture, containing hydrogen gas as a product, is discharged in the micro reactor module of this embodiment.

Specifically, the air/fuel mixture formed of the gas fuel and the air, which is supplied to the pipe member 632, is supplied to the combustion passage 625 of the first combustor 612 via the through hole 672, the combustion fuel supply passage 716, and the through hole 676, and causes the combustion reaction. The steam and the like as the products after the combustion reaction are supplied to the exhaust gas passage 714 via the through hole 677, and are discharged via the through hole 673 and the pipe member 630. Moreover, the combustion mixture formed of the gas fuel and the air, which is supplied to the pipe member 628, is supplied to the combustion chamber 712 of the second combustor 614 via the through hole 672 and the combustion fuel supply passage 710, and causes the combustion reaction. The steam and the like as the products after the combustion reaction are supplied to the exhaust gas passage 714, are discharged via the through hole 673 and the pipe member 630.

Moreover, the liquid fuel and the water, which are supplied to the liquid fuel introduction pipe 622 of the vaporizer 610, are heated and vaporized by the first combustor 612, and a mixture of the vaporized fuel and water is supplied to the reformer 400 via the reformed fuel supply passage 702 and the introduction port 432. The reformed gas containing the hydrogen gas, which is generated by the reformer 400, is supplied to the mixing chamber 708 of the low-temperature reaction portion 606 via the discharge port 434 and the communication passage 704. Meanwhile, the air supplied to the pipe member 634 is supplied to the mixing chamber 708 via the through hole 675 and the air supply passage 706, and is mixed with the air/fuel mixture containing the reformed gas supplied form the reformer 400. The mixture of the air and the reformed gas which are mixed by the mixing chamber 708 is supplied into the carbon monoxide remover 500A through the introduction port 532. The air/fuel mixture from which carbon monoxide is removed by the carbon monoxide remover 500A is discharged via the discharge port 534, the discharge chamber 718, the through hole 671 and the pipe member 626.

### [Heat-Insulating Package]

FIG. 11 is an exploded perspective view of the heat-insulating package covering the microreactor module of this embodiment when viewed from obliquely below.

As shown in FIG. 11, the microreactor module 600 includes the heat-insulating package 791 housing the high-temperature reaction portion 604, the low-temperature reaction portion 606, and the coupling portion 608.

The heat-insulating package 791 is composed of a rectangular case 792 of which lower surface is open, and a plate 793 closing such a lower surface opening of the case 792, in which the plate 793 is joined to the case 792. The heat-insulating package 791 reflects heat radiation from the microreactor module 600, and restricts the heat radiation from being propagated to the outside of the heat-insulating package 791. An inner space between the heat-insulating package 791 and the microreactor module 600 is evacuated so that the inner pressure of the heat-insulating package 791 can be a pressure lower than the atmospheric pressure, for example, a pressure equal to or less than 1 Pa.

The pipe member 634 serving as a hydrogen gas discharge passage of the supply/discharge portion 602 is exposed from the heat-insulating package 791, and is coupled to a fuel electrode of a power generation cell 808 to be described later. The liquid fuel introduction pipe 622 is coupled to a fuel container 804 through a flow rate control unit 806.

A lead wire group 739 having the lead wires 732, 731, 733, 734, 736, 735, 737 and 738 is partially exposed from the heat-insulating package 791. It is desirable that, in the lead wire group 739, the respective lead wires be spaced from one another so that intervals therebetween can be equal to one another, and be arranged around the liquid fuel introduction pipe 622.

There is an apprehension that such gaps may occur, in which the external air enters into the heat-insulating package 791 from the respective portions exposed from the heat-insulating package 791, the portions being of the liquid fuel introduction pipe 622, the pipe members 626, 628, 630, 632 and 634 and the lead wires 732, 731, 733, 734, 736, 735, 737 and 738, and the inner pressure of the heat-insulating package 791 is thereby increased. In order to prevent the occurrence of the gaps, the liquid fuel introduction pipe 622, the pipe members 626, 628, 630, 632 and 634 and the lead wires 732, 731, 733, 734, 736, 735, 737 and 738 are joined to the base plate 793 of the heat-insulating package 791 by metal wax, a glass material, or an insulating sealing material.

With such a configuration, the inner pressure of the inner space of the heat-insulating package 791 can be maintained to be low. Accordingly, a medium that propagates the heat generated by the microreactor module 600 becomes lean, and heat convection in the inner space can be suppressed. Therefore, a heat insulation effect of the microreactor module 600 can be increased.

Since the heat-insulating package 791 is made of the metal, the heat-insulating package 791 exhibits conductivity. Meanwhile, since the lead wires 732, 731, 733, 734, 736, 735, 737 and 738 are coated with a high-melting point insulator, the lead wires 732, 731, 733, 734, 736, 735, 737 and 738 do not individually conduct to the heat-insulating package 791.

Then, in the space sealed by the heat-insulating package 791, the coupling portion 608 with a predetermined length is interposed between the high-temperature reaction portion 604 and low-temperature reaction portion 606 of the microreactor module 600. A capacity of the coupling portion 608 is extremely smaller than capacities of the high-temperature reaction portion 604 and the low-temperature reaction portion 606. Accordingly, heat propagation from the high-temperature reaction portion 604 to the low-temperature reaction portion 606 by the coupling portion 608 is suppressed. A thermal gradient required for the reaction can be maintained between the high-temperature reaction portion 604 and the low-temperature reaction portion 606. Moreover, it can be facilitated to uniform the temperature in the high-temperature reaction portion 604, and to equalize the temperature in the low-temperature reaction portion 606.

Moreover, on the surface of the low-temperature reaction portion 606, a getter material 728 may be provided, which maintains the inner pressure of the inner space of the heat-insulating package 791 to be low by adsorbing factors to increase the pressure of the inner space of the heat-insulating package 791, such as residual gas as a result of insufficient evacuation when the case 792 and the base plate 793 are joined to each other, gas that has leaked from the microreactor module 600 to the inner space of the heat-insulating package 791, and gas that has entered from the outside into the heat-insulating package 791. Furthermore, the getter material 728 may be composed in such a manner that a heater such as an electro thermal material for heating is provided, and that wires (not shown) in which the lead wires 737 and 738 are connected to both ends are connected to this heater. The getter material 729 is a material that is activated by being heated and has a function to adsorb the gas. As a material of the getter material 728, an alloy mainly containing zirconium, barium, titanium, or vanadium is mentioned.

Moreover, a position where the getter material 728 is provided is not limited to the surface of the low-temperature reaction portion 606, and may be a surface of the high-temperature reaction portion 604, an upper portion of the coupling portion 608, or an inner surface side of the heat-insulating package 791. It is preferable to provide the getter material 728 inside of the gap between the high-temperature reaction portion 604 and the low-temperature reaction portion 606. In such a way, the size of the heat-insulating package 791 can be restricted from being increased.

As described above, a plurality of through holes 795 penetrate through the plate 793, and these through holes 795 are sealed by the metal or the glass material in a state where the pipe members 626, 628, 630, 632 and 634, the liquid fuel introduction pipe 622, and the lead wires 731 to 738 are inserted through the respective through holes 795.

Although the inner space of the heat-insulating package 791 is hermetically sealed, the pressure of the inner space is reduced, and accordingly, a high heat insulation effect is brought to the heat-insulating package 791. Therefore, a heat loss of the heat-insulating package 791 can be suppressed.

### [Study on Heat Insulation Performance]

Next, a description will be made of heat insulation performance of the heat-insulating package 791 in the microreactor module 600 of this embodiment based on a relationship of the heat loss with respect to a distance (thickness of the vacuum layer) between the reaction container that forms the reformer 400 and the carbon monoxide remover 500A and the inner wall surface of the heat-insulating package 791 and a relationship between a surface temperature of the heat-insulating package and a displacement of the top plate of the reaction container.

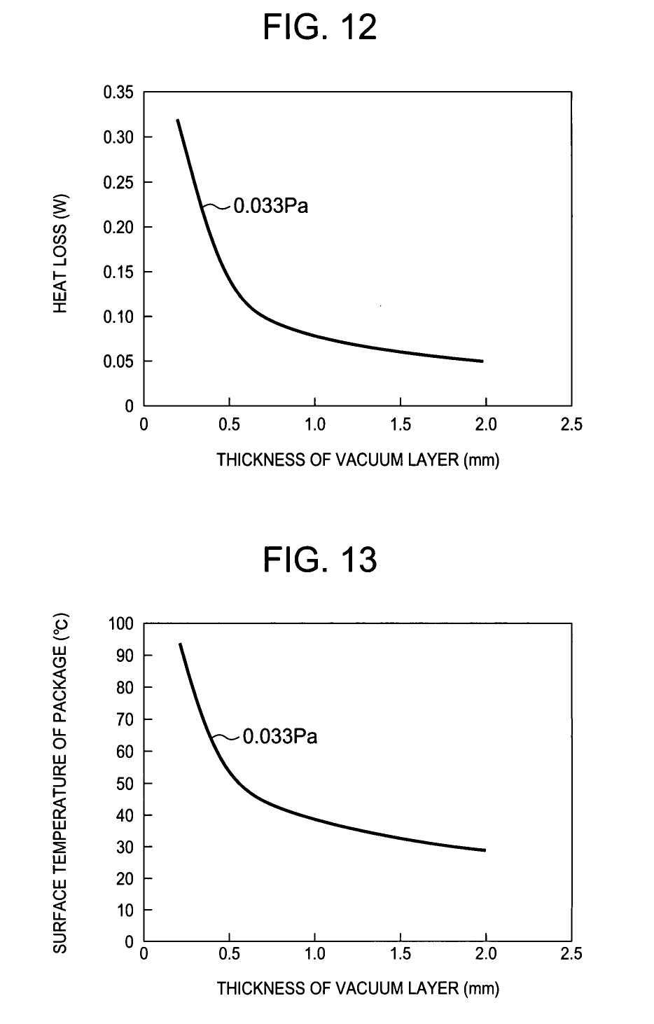

FIG. 12 is a graph showing a result of calculating the relationship between the heat loss and the thickness of the vacuum layer in the microreactor module of this embodiment.

FIG. 13 is a graph showing a result of calculating the relationship between the surface temperature of the heat-insulating package and the thickness of the vacuum layer in the microreactor module of this embodiment.

Here, the calculation was performed under the following conditions. Stainless steel (SUS304) was used as a material of the reaction container and the heat-insulating package, a dimension of the reaction container was set as: 23 mm×16 mm×5.2 mm, an initial temperature of the reaction container was set at 380° C., the external temperature was set at 20° C., and the pressure in the heat-insulating package was set at 0.033 Pa.

From FIG. 12, it is understood that the heat loss is reduced as the distance between the reaction container and the inner wall surface of the heat-insulating package is being larger. Moreover, from FIG. 13, it is understood that a rise of the surface temperature of the heat-insulating package can be prevented as the distance between the reaction container and the inner wall surface of the heat-insulating package is being larger. From these graphs, it is evaluated that the minimum distance (thickness of the vacuum layer) required between the reaction container and the inner wall surface of the heat-insulating package is approximately 0.75 mm in order to maintain the surface temperature of the heat-insulating package at the normal temperature (approximately 40° C.).

In order to miniaturize the apparatus, it is desired that the distance between the reaction container and the inner wall surface of the heat-insulating package be minimized. Accordingly, in the case of setting the distance between the reaction container and the inner wall surface of the heat-insulating package at 1 mm, it is necessary to suppress the displacement of the reaction container to approximately 0.25 mm(=1 mm−0.75 mm) in order to prevent the distance from being smaller than 0.75 mm. Accordingly, a description will be made of the displacement of the top plate when the top plate and the partition plates are joined and are not joined in the case of changing the thickness of the top plate of the reaction container in the microreactor module 600 of this embodiment to 0.05 mm, 0.1 mm, and 0.2 mm.

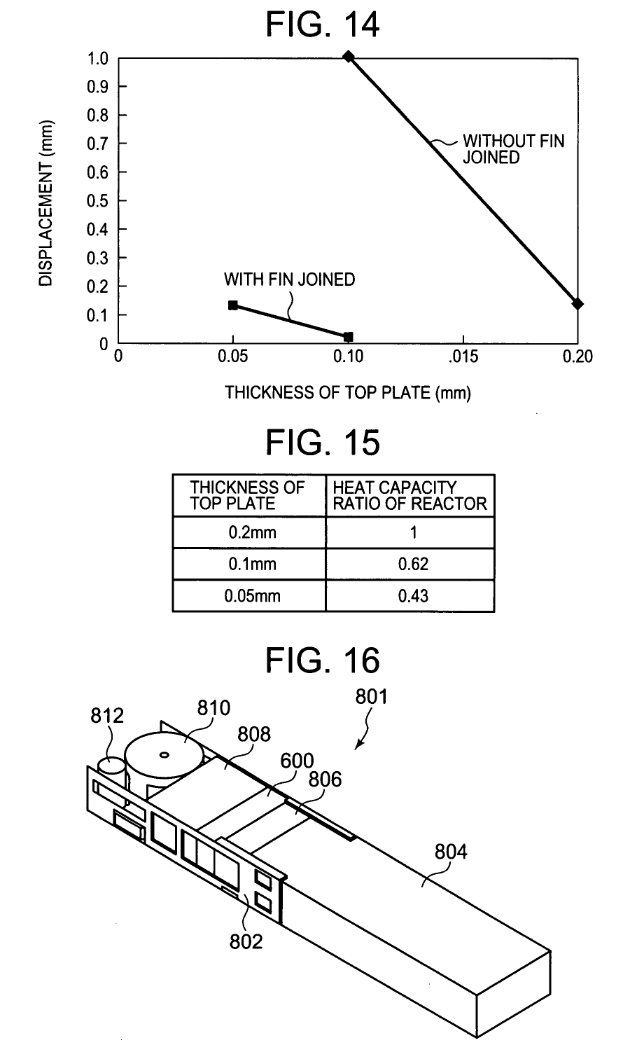

FIG. 14 is a diagram showing results of calculating amounts of deformation of the reaction container with respect to the thickness of the top plate when the top plate and partition plates of the reaction container in the microreactor module of this embodiment are joined to each other (with fins joined) and are not joined to each other (without fins joined).

Here, the calculation was performed under the following conditions. The stainless steel (SUS304) was used as the material of the reaction container and the heat-insulating package, the dimension of the reaction container was set as: 23 mm×16 mm×5.2 mm, the thickness of the partition plates was set at 0.1 mm, the number of partition plates was set at seven, the initial temperature of the reaction container was set at 380° C., the external temperature was set at 20° C., the pressure in the reaction container was set at 101325 Pa (atmospheric pressure), and the pressure of the heat-insulating package was set at 0.033 Pa.

As shown in FIG. 14,

(1) In the case where the top plate and the partition plates were not joined to each other:

When the thickness of the top plate was set at 0.2 mm, the displacement of the top plate became 0.13 mm;

when the thickness of the top plate was set at 0.1 mm, the displacement of the top plate became 1 mm; and

when the thickness of the top plate is set at 0.05 mm, it is supposed that the displacement of the top plate becomes 1 mm or more.

(2) In the case where the top plate and the partition plates were joined to each other:

When the thickness of the top plate was set at 0.05 mm, the displacement of the top plate became 0.13 mm;

when the thickness of the top plate was set at 0.1 mm, the displacement of the top plate became 0.02 mm; and

when the thickness of the top plate is set at 0.2 mm, it is supposed that the displacement of the top plate becomes 0.02 mm or less, that is, the top plate is hardly deformed substantially.

From the results as described above, it is understood that, in the case where the top plate and the partition plates are not joined to each other, it is necessary that the thickness of the top plate is at least approximately 0.2 mm in order to suppress the displacement of the reaction container at 0.25 mm or less. Meanwhile, it is understood that, in the case where the top plate and the partition plates are joined to each other, no problem occurs even if the thickness of the top plate is 0.05 mm.

Next, a description will be made of heat capacities of the reaction container in the microreactor module 600 of this embodiment when the thickness of the top plate is set at 0.2 mm, 0.1 mm, and 0.05 mm.

FIG. 15 is a table showing results of calculating heat capacity ratios of the reaction container in the case of changing the thickness of the top plate of the reaction container in the microreactor module of this embodiment.

Here, the calculation was performed under conditions where the stainless steel (SUS304) was used as the material of the reaction container and the heat-insulating package, the dimension of the reaction container was set as: 23 mm×16 mm×5.2 mm, the thickness of the partition plates was set at 0.1 mm, and the number of partition plates was set at seven.

As shown in FIG. 15, in the case where the heat capacity of the reaction container when the thickness of the top plate was set at 0.2 mm was defined as 1, the heat capacity of the reaction container when the thickness of the top plate was set at 0.1 mm became 0.62, and the heat capacity of the reaction container when the thickness of the top plate was set at 0.05 mm became 0.43.

Hence, when the thickness of the top plate is set at 0.05 mm, the heat capacity of the reaction container can be reduced by half in comparison with the case where the thickness of the top plate is set at 0.2 mm. Therefore, in the case of heating the reaction container by the heater at the time of activation, an activation time taken until the reaction container reaches the predetermined temperature can be reduced by half in comparison with the case where the thickness of the top plate is set at 0.2 mm. As described above, with the structure in which the top plate and the partition plates in this embodiment are joined to each other, the thickness of the top plate can be reduced approximately by quarter with respect to the structure in which the top plate and the partition plates are not joined to each other if the displacements are set approximately the same. In such a way, the weight of the reaction container can be reduced to a large extent while maintaining the strength of the reaction container. Moreover, the heat capacity of the reaction container is reduced, whereby the activation time taken until the reaction container is set at the predetermined temperature by being heated can be shortened to a large extent.

### [Operation of Microreactor Module]

Next, a description will be made of an operation of the microreactor module 600 in this embodiment.

First, when the voltage is applied between the lead wires 737 and 738, the getter material 728 is heated by the heater, and the getter material 728 is activated. In such a way, the factors, such as the gas, to increase the pressure of the heat-insulating package 791 are adsorbed by the getter material 728, a degree of pressure reduction in the heat-insulating package 791 is increased, and the heat insulation efficiency is increased.

Moreover, when the voltage is applied between the lead wires 731 and 732, the heating wire 720 generates heat, and the low-temperature reaction portion 606 is heated. When the voltage is applied between the lead wires 733 and 734, the heating wire 722 generates heat, and the high-temperature reaction portion 604 is heated. When the voltage is applied between the lead wires 735 and 736, the heating wire 724 generates heat, and the upper portion of the liquid fuel introduction pipe 622 is heated. The liquid fuel introduction pipe 622, the high-temperature reaction portion 604, the low-temperature reaction portion 606, and the coupling portion 608 are made of the metal material, and accordingly, the heat conducts easily there among. Note that the currents and voltages of the heating wires 720, 722 and 724 are measured by a control device, whereby the temperatures of the liquid fuel introduction pipe 622, the high-temperature reaction portion 604, and the low-temperature reaction portion 606 are measured, feedback of the measured temperatures is made to the control device, and the voltages of the heating wires 720, 722 and 724 are controlled by the control device. In such a way, the temperatures of the liquid fuel introduction pipe 622, the high-temperature reaction portion 604, and the low-temperature reaction portion 606 are controlled.

When the mixed solution of the fuel liquid and the water is supplied continuously or intermittently by a pump or the like in a state where the liquid fuel introduction pipe 622, the high-temperature reaction portion 604, and the low-temperature reaction portion 606 are heated by the heating wires 720, 722 and 724, the mixed solution is absorbed by the liquid-absorbent material 623, and the mixed solution permeates upward the inside of the liquid fuel introduction pipe 622 by the capillary phenomenon. Then, the mixed solution in the liquid-absorbent material 623 is vaporized, and a mixture of the fuel and the water transpires from the liquid-absorbent material. Since the mixed solution is vaporized in the liquid-absorbent material 623, bumping can be suppressed, and stable evaporation can be achieved.

Then, the mixture that has transpired from the liquid-absorbent material 623 flows into the reformer 400 through the through hole 678, the reformed fuel supply passage 702, and the introduction port 432. Thereafter, when the mixture flows in the reformer 400, the mixture is heated to cause the catalytic reaction, and the hydrogen gas and the like are thereby generated (when the fuel is methanol, refer to the above-described chemical formulas (1) and (2)).

The mixture (reformed gas: hydrogen gas, containing carbon dioxide gas, carbon monoxide gas, and the like) flows into the mixing chamber 708 through the discharge port 434 and the communication passage 704. Meanwhile, the air is supplied to the pipe member 634 by the pump or the like, and flows into the mixing chamber 708 through the through hole 675 and the air supply passage 706. In such a way, the mixture of the hydrogen gas and the like and the water are mixed together.

Then, the mixture containing the air, the hydrogen gas, the carbon monoxide gas, the carbon dioxide gas, and the like flows into the carbon monoxide remover 500A from the mixing chamber 708 through the introduction port 532. When the mixture flows in the carbon monoxide remover 500A, the carbon monoxide gas in the mixture is selectively oxidized, and the carbon monoxide gas is removed.

Here, the carbon monoxide gas is not reacted uniformly in the carbon monoxide remover 500A, and a reaction rate of the carbon monoxide gas is increased in a downstream side in the passage of the carbon monoxide remover 500A. The liquid fuel introduction pipe 622 is located under such a downstream portion, and accordingly, heat generated by the oxidation reaction of the carbon monoxide gas is efficiently used as heat of vaporization for the water and the fuel.

Then, the mixture in a state where carbon monoxide is removed therefrom is supplied to the fuel electrode and the like of the fuel cell from the discharge port 534 via the discharge chamber 718, the through hole 671, and the pipe member 626.

In the fuel cell, the electricity is generated by the electrochemical reaction of the hydrogen gas, and the off-gas containing the unreacted hydrogen gas and the like is discharged form the fuel cell.

The above-described operation is an operation at the initial stage, and, also thereafter, the mixed solution is continuously supplied to the liquid fuel introduction pipe 622.

Then, the air is mixed to the off-gas discharged from the fuel cell, and such a mixture thus obtained (hereinafter, referred to as the “combustion mixture”) is supplied to the pipe member 632 and the pipe member 628. The combustion mixture supplied to the pipe member 632 flows into the combustion passage 625 through the through hole 674, the combustion fuel supply passage 716, and the through hole 676, and the combustion mixture is subjected to the catalytic combustion in the combustion passage 625. In such a way, the combustion heat is generated. Since the combustion passage 625 goes around the liquid fuel introduction pipe 622 under the low-temperature reaction portion 606, the liquid fuel introduction pipe 622 and the low-temperature reaction portion 606 are heated by the combustion heat. Therefore, power consumption of the heating wires 720 and 724 can be reduced, and utilization efficiency of the energy is enhanced.

Meanwhile, the combustion mixture supplied to the pipe member 628 flows into the combustion chamber 712 through the through hole 672 and the combustion fuel supply passage 710, and is subjected to the catalytic combustion in the combustion chamber 712. In such a way, the combustion heat is generated, and the reformer 400 is heated by the combustion heat. Therefore, power consumption of the heating wire 722 can be reduced, and the utilization efficiency of the energy is enhanced.

Here, the high-temperature reaction portion 604 must be held at a higher temperature than the temperature of the low-temperature reaction portion 606. Accordingly, a hydrogen supply amount in the off-gas per unit time in the second combustor 614 is set larger than a hydrogen supply amount in the off-gas per unit time in the first combustor 612. Alternatively, a supply amount per unit time of oxygen (air) serving as a refrigerant in the first combustor 612 may be set larger than a supply amount per unit time of oxygen (air) in the second combustor 614.

Note that a configuration may be adopted, in which the liquid fuel reserved in the fuel container is vaporized, and a combustion mixture of the vaporized fuel and the air is supplied to the pipe members 628 and 632.

In a state where the mixed solution is supplied to the liquid fuel introduction pipe 622, and in a state where the combustion mixture is supplied to the pipe members 628 and 632, the control device controls the voltages to be applied to the heating wires 720, 722 and 724 and controls the pump or the like while measuring the temperatures by the heating wires 720, 722 and 724. When the pump is controlled by the control device, a flow rate of the combustion mixture supplied to the pipe members 628 and 632 is controlled, whereby combustion calories of the combustors 612 and 614 are controlled. The control device controls the heating wires 720, 722 and 724 and the pump as described above, whereby the temperatures of the liquid fuel introduction pipe 622, the high-temperature reaction portion 604, and the low-temperature reaction portion 606 are controlled. Here, such a temperature control is performs so that the temperature of the high-temperature reaction portion 604 can be 375° C. and that the temperature of the low-temperature reaction portion 606 can be 150° C.

### [Power Generation Unit]

Next, a description will be made of an example of a power generation unit including the microreactor module 600 in this embodiment.

FIG. 16 is a perspective view showing the example of the power generation unit including the microreactor module in this embodiment.

As shown in FIG. 16, the microreactor module 600 as described in the foregoing embodiment can be used by being assembled to a power generation unit 801. This power generation unit 801 includes, for example, a frame 802, the fuel container 804 detachable from the frame 802, the flow rate control unit 806 having a passage, a pump, a flow rate sensor, a valve, and the like, the microreactor module 600 in a state of being housed in the heat-insulating package 791, a power generation cell 808 having the fuel cell, a humidifier, a collector and the like, an air pump 810, and a power source unit 812 having a secondary battery, a DC-DC converter, an external interface, and the like.

The mixture of the water and the liquid fuel in the fuel container 804 is supplied to the microreactor module 600 by the flow rate control unit 806, whereby the hydrogen gas is generated as described above, the hydrogen gas is supplied to the fuel cell of the power generation cell 808, and the generated electricity is accumulated in the secondary battery of the power source unit 812.

### [Electronic Instrument]

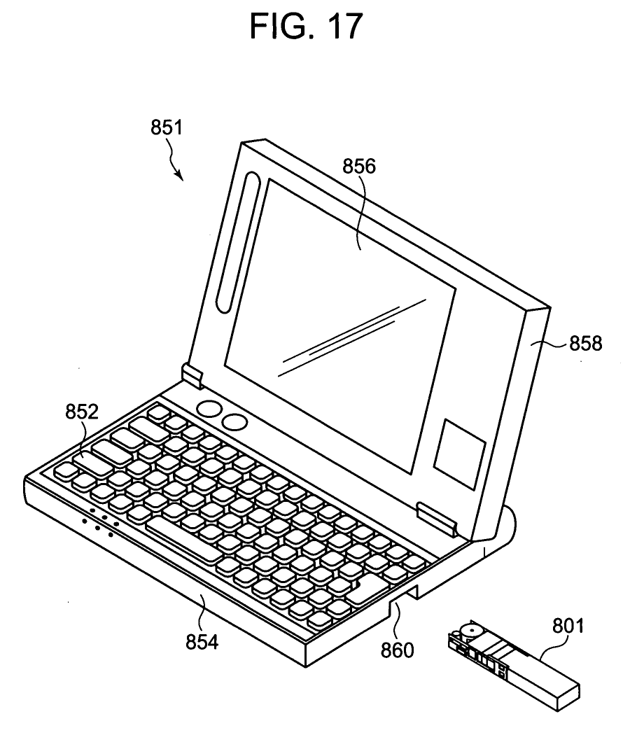

FIG. 17 is a perspective view showing an example an electronic instrument using the power generation unit as a power source.

As shown in FIG. 17, this electronic instrument 851 is a portable electronic instrument, for example, is a notebook personal computer.

The electronic instrument 851 includes a lower cabinet 854 building therein a computational operation processing circuit composed of a CPU, a RAM, a ROM, and other electronic parts and having a keyboard 852 installed thereon, and an upper cabinet 858 having a liquid crystal display 856 installed thereon. The lower cabinet 854 and the upper cabinet 858 are coupled to each other by a hinge, and are constructed so as to be foldable in a state where the upper cabinet 858 is placed on the lower cabinet 854 and the liquid crystal display 856 is opposed to the keyboard 852. An attachment portion 860 for receiving the power generation unit 801 is provided in a recessed manner from a right side surface of the lower cabinet 854 to a bottom surface thereof. When the power generation unit 801 is attached into the attachment portion 860, the electronic instrument 851 operates by the electricity of the power generation unit 801.

Note that the present invention is not limited to the above-described embodiment, and various improvements and design changes may be performed within the scope without departing from the gist of the present invention.

### MODIFICATION EXAMPLE 1

A description will be made of a first modification example of the microreactor module 600 in the above-described embodiment of the present invention. Note that portions other than a carbon monoxide remover 500B (reaction container) and a part of the base plate 642, which will be described later, are similar to those of the first embodiment, and accordingly, a description of the other portions will be omitted.

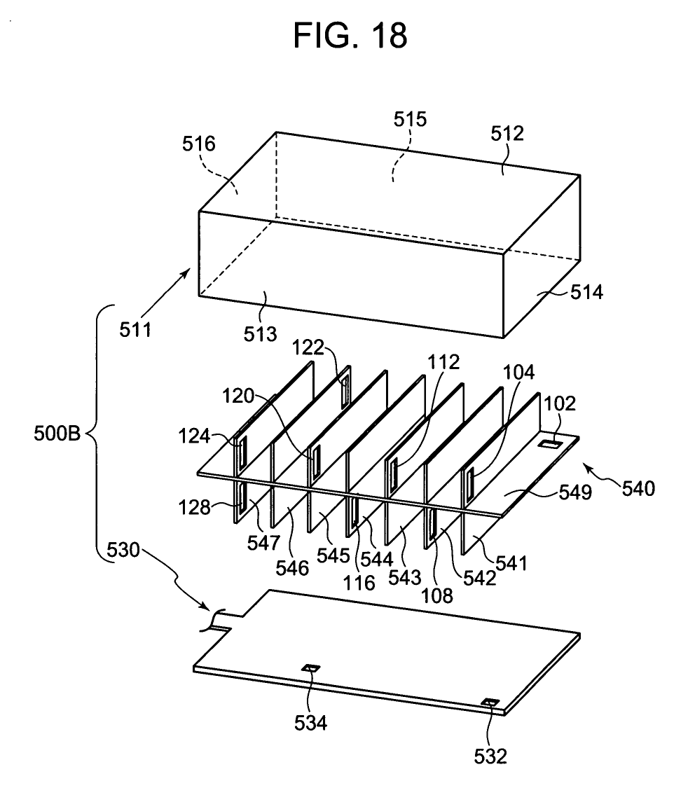

FIG. 18 is an exploded perspective view showing the carbon monoxide remover in the first modification example of the microreactor module of the present invention.

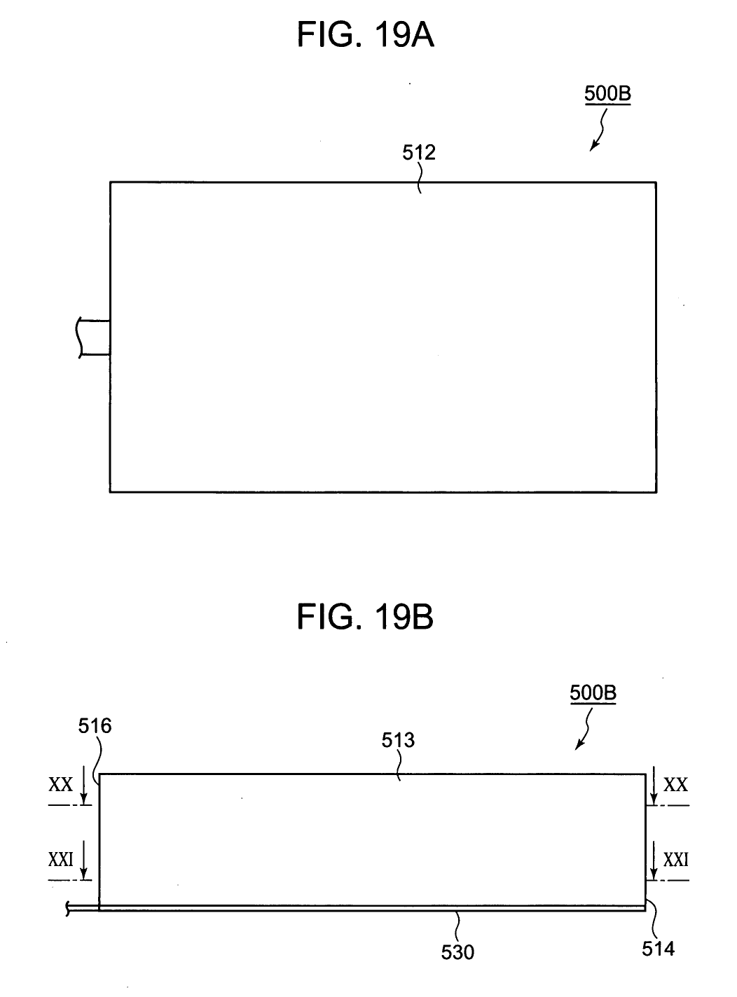

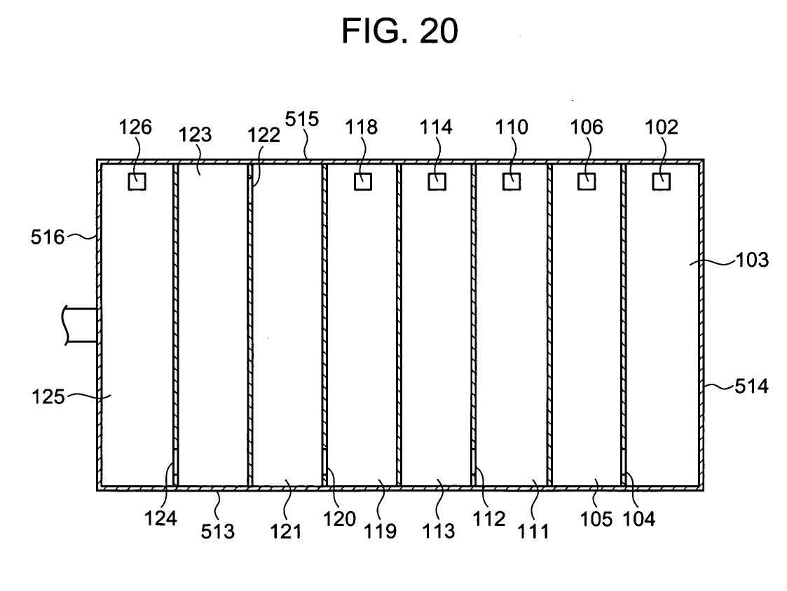

FIG. 19A is a plan view of the carbon monoxide remover in the first modification example, and FIG. 19B is a side view thereof.

FIG. 20 is a cross-sectional view taken along a line XX-XX of FIG. 19B.

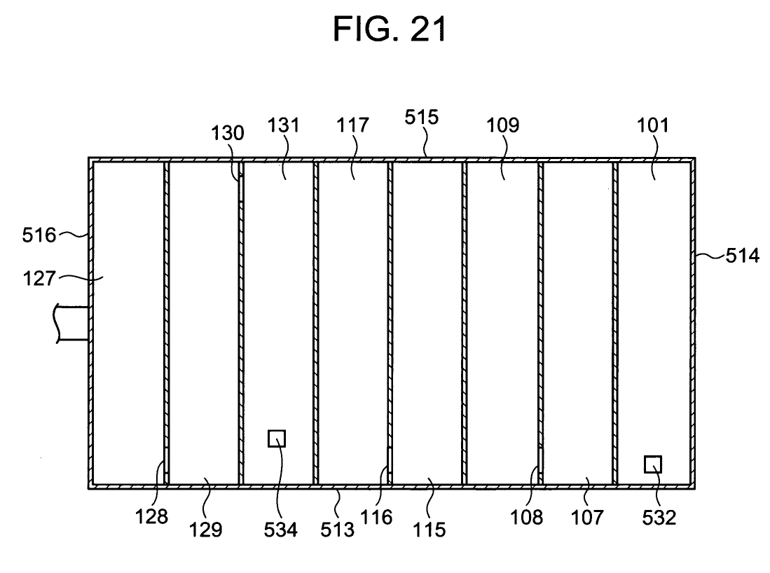

FIG. 21 is a cross-sectional view taken along a line XXI-XXI of FIG. 19B.

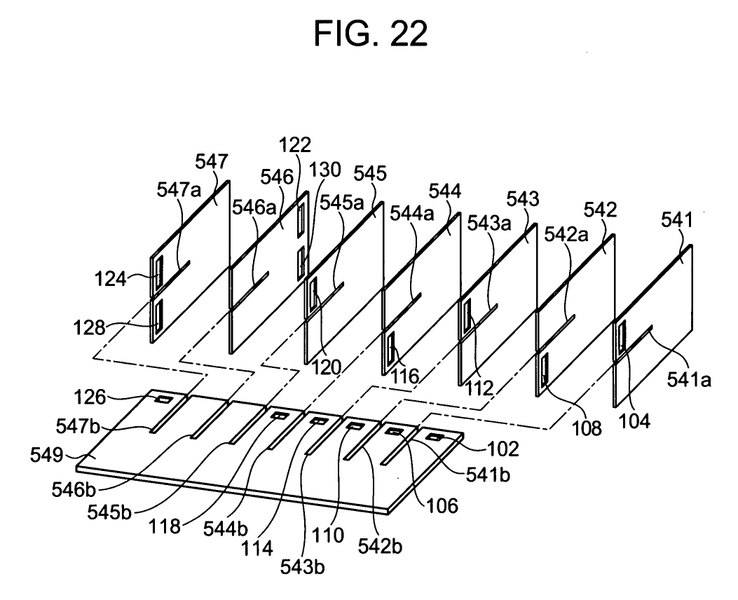

FIG. 22 is an exploded perspective view of a partition member for use in the carbon monoxide remover in the first modification example.

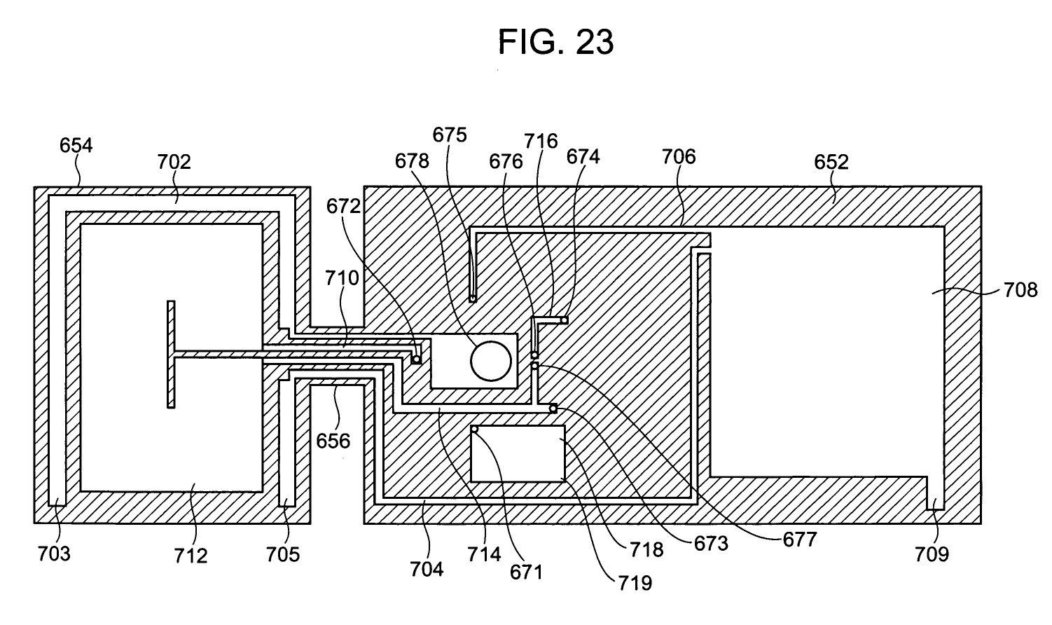

FIG. 23 is a cross-sectional view showing a configuration of the base plate ready for the carbon monoxide remover in the first modification example.

As shown in FIG. 18, the carbon monoxide remover 500B in the first modification example is composed of a box body 511, a bottom plate 530, and a partition member 540. Note that, with regard to the box body 511 and the bottom plate 530, the same reference numerals as those of the first embodiment are assigned thereto, and a description thereof will be omitted.

An edge of the bottom plate 530 is joined to lower sides of side plates 513 to 516 so that the bottom plate 530 can be made parallel to the top plate 12. A lower surface opening of the box body 511 is closed by the bottom plate 530 in a state where the partition member 540 is housed in the box body 511, whereby a tetrahedral reaction container having a hollow space is composed.

On ends of the bottom plate 530 on the side plate 513 side, there are provided an introduction port 532 for introducing the reactant into the carbon monoxide remover 500B, and a discharge port 534 for discharging the product to the outside of the carbon monoxide remover 500B. The introduction port 532 is provided between the side plate 514 and a partition plate 541 to be described later, and the discharge port 534 is provided between partition plates 545 and 546 to be described later. Note that, as shown ion FIG. 23, in the base plate 642 in this modification example, a position of the discharge chamber 718 is changed in accordance with a position of the discharge port 534, and the discharge port 534 is disposed above a corner 719.

As shown in FIG. 22, the partition member 540 is composed of seven partition plates 541, 542, 543, 544, 545, 546 and 547, and a floor plate 549.

The partition plates 541, 542, 543, 544, 545, 546 and 547 are provided parallel to the side plates 514 and 516, and divide an inside of the carbon monoxide remover 500B into eight rows. At the respective center positions of the partition plates 541, 542, 543, 544, 545, 546 and 547 in the height direction, slits 541a, 542a, 543a, 544a, 545a, 546a and 547a are provided parallel to the floor plate 549 from the side plate 513 side. Heights of the slits 541a, 542a, 543a, 544a, 545a, 546a and 547a are equal to a thickness of the floor plate 549. Ends of the partition plates 541, 542, 543, 544, 545, 546 and 547 on the side plate 513 side are vertically divided into halves by the slits 541a, 542a, 543a, 544a, 545a, 546a and 547a.

In the first, third and fifth partition plates 541, 543 and 545 from the side plate 514 side, on upper ends thereof on the side plate 513 side, connection ports 104, 112 and 120 that penetrate through the partition plates 541, 543 and 545 are provided.

In the second and fourth partition plates 542 and 544 from the side plate 514 side, on lower ends thereof on the side plate 513 side, connection ports 108 and 116 that penetrate through the partition plates 542 and 544 are provided.

In the sixth partition plate 546 from the side plate 514 side, on an end thereof on the side plate 515 side, two upper and lower connection ports 122 and 130 that penetrate through the partition plate 546 are provided.

In the seventh partition plate 547 from the side plate 514 side, on both upper and lower ends thereof on the side plate 513 side, connection ports 124 and 128 that penetrate through the partition plate 547 are provided, respectively.

Upper ends of the respective partition plates 541, 542, 543, 544, 545, 546 and 547 are joined to the top plate 512 by welding or brazing.

In a state of being housed in the carbon monoxide remover 500B, the floor plate 540 is provided parallel to the top plate 512 and the bottom plate 530, and vertically divides the inside of the carbon monoxide remover 500B into halves. As shown in FIG. 22, in the floor plate 549, seven slits 541b, 542b, 543b, 544b, 545b, 546b and 547b from the side plate 515 side are provided at an equal interval in parallel to the partition plates 541, 542, 543, 544, 545, 546 and 547. Widths of the slits 541b, 542b, 543b, 544b, 545b, 546b and 547b are equal to thicknesses of the partition plates 541, 542, 543, 544, 545, 546 and 547, respectively.

Moreover, an end of the floor plate 549 on the side plate 515 side is divided into eight equal portions by the seven slits 541b, 542b, 543b, 544b, 545b, 546b and 547b. Among ends of the eight portions, in the first to fifth and eighth ends from the side plate 514 side, the connection ports 102, 106, 110, 114, 118 and 126 that penetrate through the floor plate 549 are provided.

The slits 541b, 542b, 543b, 544b, 545b, 546b and 547b correspond to the slits 541a, 542a, 543a, 544a, 545a, 546a and 547a of the partition plates 541, 542, 543, 544, 545, 546 and 547, respectively, and are formed so that the sum of lengths of these slits 541b, 542b, 543b, 544b, 545b, 546b and 547b can be longer than lengths of the slits of the floor plate 549 and the partition plates 541, 542, 543, 544, 545, 546 and 547.

The floor plate 549 and the partition plates 541, 542, 543, 544, 545, 546 and 547 are combined so that the floor plate 549 can be sandwiched by portions of the slits 541a, 542a, 543a, 544a, 545a, 546a and 547a, and that the partition plates 541, 542, 543, 544, 545, 546 and 547 can be sandwiched by portions of the slits 541b, 542b, 543b, 544b, 545b, 546b and 547b, respectively, and are thereby assembled perpendicularly to each other. Note that such assembled portions may be welded or brazed. By being welded or brazed, the floor plate 549 and the partition plates 541, 542, 543, 544, 545, 546 and 547 can be certainly fixed to each other. Moreover, peripheral edges of the floor plate 549 and the partition plates 541, 542, 543, 544, 545, 546 and 547 abut on inner surfaces of the top plate 12, the bottom plate 530 and the side plates 513 to 516, and are joined thereto by welding or brazing.

As shown in FIG. 20 and FIG. 21, the inside of the carbon monoxide remover 500B is divided by the partition member 540 into sixteen reaction chambers 101, 103, 105, 107, 109, 111, 113, 115, 117, 119, 121, 123, 125, 127, 129 and 131.

Specifically, the inside of the carbon monoxide remover 500B is divided by the floor plate 549 into an upper stage (between the floor plate 549 and the top plate 512) and a lower stage (between the bottom plate 530 and the floor plate 549). As shown in FIG. 21, the upper stage is divided into the eight reaction chambers 103, 105, 111, 113, 119, 121, 123 and 125 by the partition plates 541, 542, 543, 544, 545, 546 and 547. Moreover, as shown in FIG. 20, the lower stage is divided into the eight reaction chambers 101, 107, 109, 115, 117, 131, 129 and 127 by the partition plates 541, 542, 543, 544, 546 and 547.

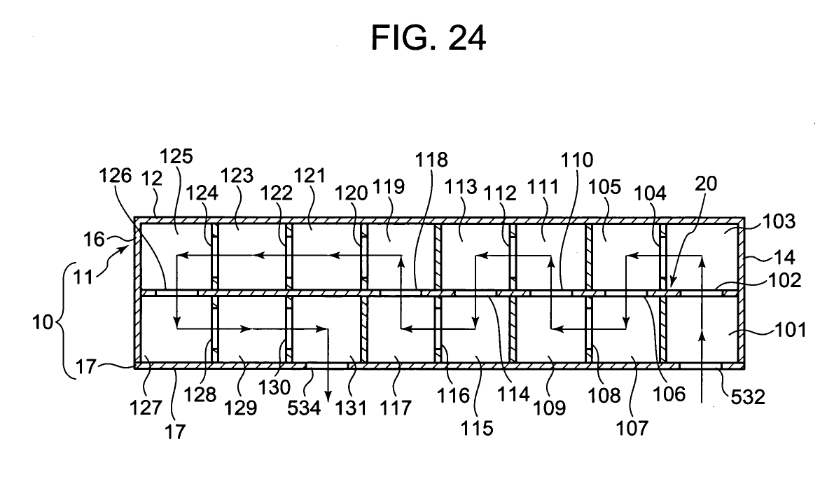

FIG. 24 is a schematic cross-sectional view cut along a plane parallel to the side plate 513, for explaining relationships among the respective reaction chambers, the introduction port, the discharge port, and the connection ports in the carbon monoxide remover of the first modification example.

The reaction chamber 101 communicates with the outside of the carbon monoxide remover 500B by the introduction port 532, and communicates with the reaction chamber 103 by the connection port 102. Moreover, the reaction chamber 131 communicates with the reaction chamber 129 by the connection port 130, and communicates with the outside of the carbon monoxide remover 500B by the discharge port 534. Each of the other reaction chambers 103, 105, 107, 109, 111, 113, 115, 117, 119, 121, 123, 125, 127 and 129 communicates with two adjacent reaction chambers by any two of the connection ports 104, 106, 108, 110, 112, 114, 116, 118, 120, 122, 124, 126 and 128.

Next, a description will be made of the passage of the reactant inside of the carbon monoxide remover 500B.

As shown by arrows in FIG. 24, the reactant first flows from the introduction port 532 into the reaction chamber 101 inside of the carbon monoxide remover 500B, and thereafter, passes through the connection port 102, the reaction chamber 103, the connection port 104, the reaction chamber 105, the connection port 106, the reaction chamber 107, the connection port 108, the reaction chamber 109, the connection port 110, the reaction chamber 111, the connection port 112, the reaction chamber 113, the connection port 114, the reaction chamber 115, the connection port 116, the reaction chamber 117, the connection port 118, the reaction chamber 119, the connection port 120, the reaction chamber 121, the connection port 122, the reaction chamber 123, the connection port 124, the reaction chamber 125, the connection port 126, the reaction chamber 127, the connection port 128, the reaction chamber 129, the connection port 130, and the reaction chamber 131 in this order, and flows out from the discharge port 534 to the outside of the carbon monoxide remover 500B.

Also in the first modification example, as in the case of the above-described embodiment, the top plate 512 and the partition plates 541, 542, 543, 544, 545, 546 and 547 are joined to each other, whereby the top plate 512 can be reinforced. In such a way, when the microreactor module 600 is housed in the heat-insulating package 791 of which inner pressure is reduced, the top plate 512 can be made hardly deformable even if the thickness of the top plate 512 is thinned to an extent to which the top plate 512 is largely deformed in the case of such a structure where the top plate 512 and the partition plates 541 to 547 are not joined to each other.

Moreover, in accordance with the first modification example, the inside of the carbon monoxide remover 500B is partitioned by the partition member 540 into the sixteen reaction chambers 101, 103, 105, 107, 109, 111, 113, 115, 117, 119, 121, 123, 125, 127, 129 and 131. Each of these reaction chambers communicates with the two adjacent reaction chambers by any of the two connection ports 102, 104, 106, 108, 110, 112, 114, 116, 118, 120, 122, 124, 126, 128 and 130 provided in the partition member 540, and a route from the introduction port 532 provided in the carbon monoxide remover 500B to the discharge port 534 provided therein is formed as one passage. Accordingly, a cross-sectional dimension of the passage can be reduced, and a diffusion time of the reactant to the catalyst provided on the surface of the passage can be thereby shortened. In addition, a length of the passage can be elongated, and a reaction time can be thereby extended.

Furthermore, the partition member 540 can be formed in the following manner. Specifically, the floor plate 549 and the partition plates 541, 542, 543, 544, 545, 546 and 547 are combined so that the floor plate 549 can be sandwiched by the portions of the slits 541b, 542b, 543b, 544b, 545b, 546b and 547b, and that the partition plates 541, 542, 543, 544, 545, 546 and 547 can be sandwiched by the portions of the slits 541a, 542a, 543a, 544a, 545a, 546a and 547a, and can be thereby assembled perpendicularly to each other. Accordingly, the partition member 540 can be assembled easily.

In order to assemble the carbon monoxide remover 500B, the reforming catalyst is first supported on the inner surface of the box body 511, the surface of the assembled partition member 540, and the upper surface of the bottom plate 530. Subsequently, the assembled partition member 540 is joined to the inside of the box body 511. Thereafter, the lower ends of the side walls 513 to 516 of the box body 511 and the outer edge of the bottom plate 530 are joined to each other, and the lower opening of the box body 511 is closed by the bottom plate 530.

### MODIFICATION EXAMPLE 2

Next, a description will be made of a second modification example of the microreactor module 600 (reaction apparatus) in the present invention. Note that portions other than a carbon monoxide remover 500C that will be described below are similar to those of the first modification example, and accordingly, a description of the other portions will be omitted.

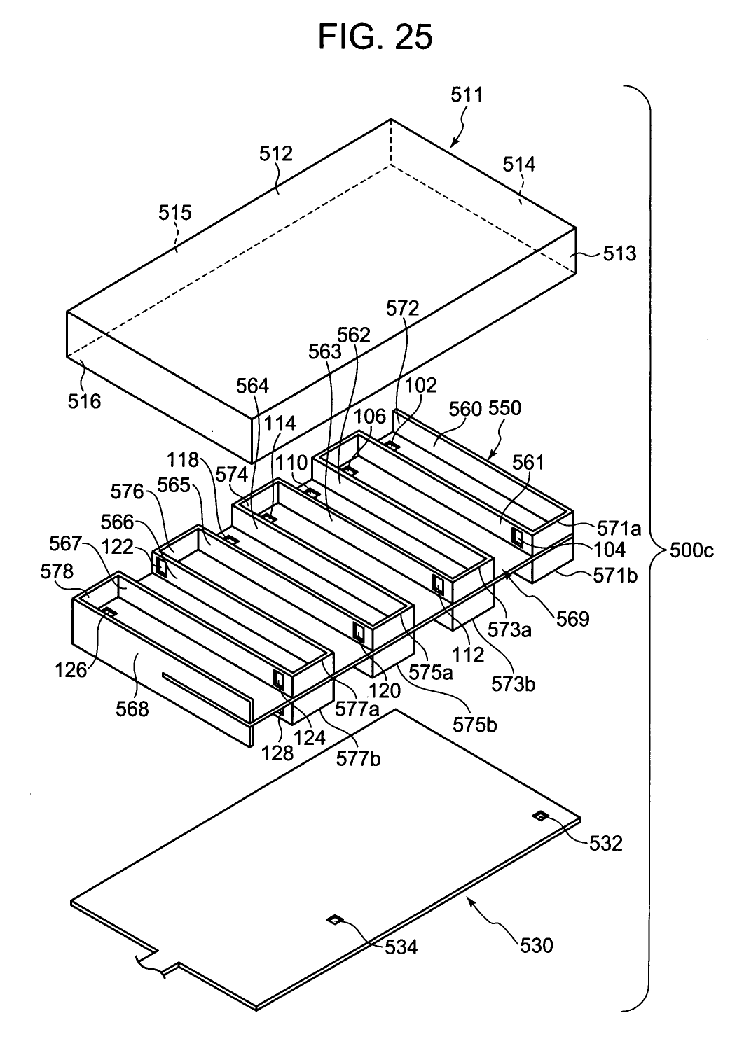

FIG. 25 is an exploded perspective view showing the carbon monoxide remover in the second modification example of the microreactor module of the present invention.

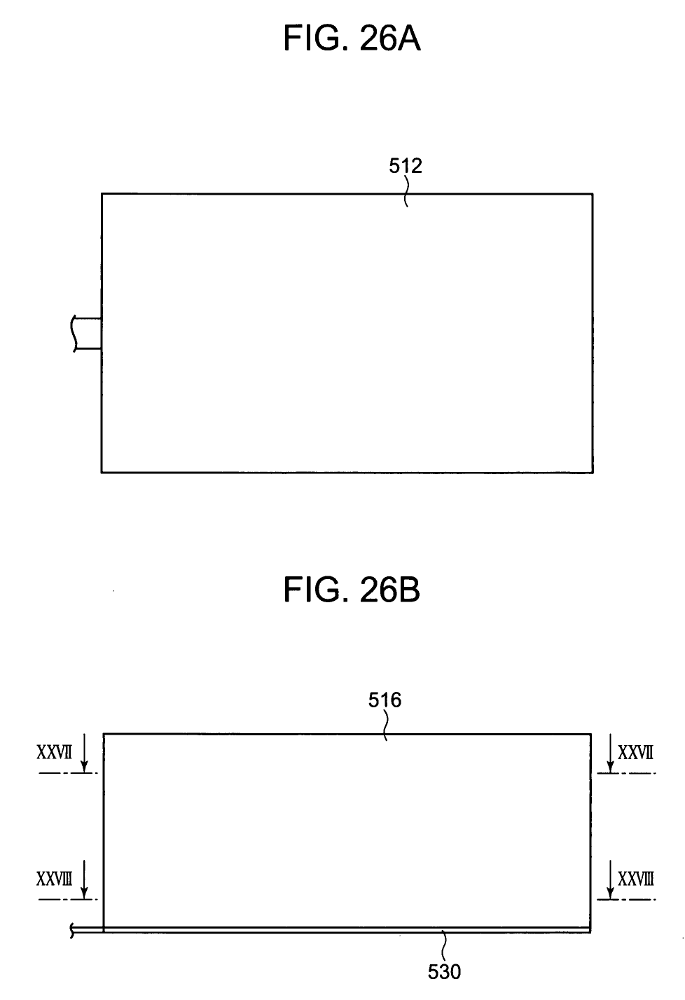

FIG. 26A is a plan view of the carbon monoxide remover in the second modification example, and FIG. 26B is a side view thereof.

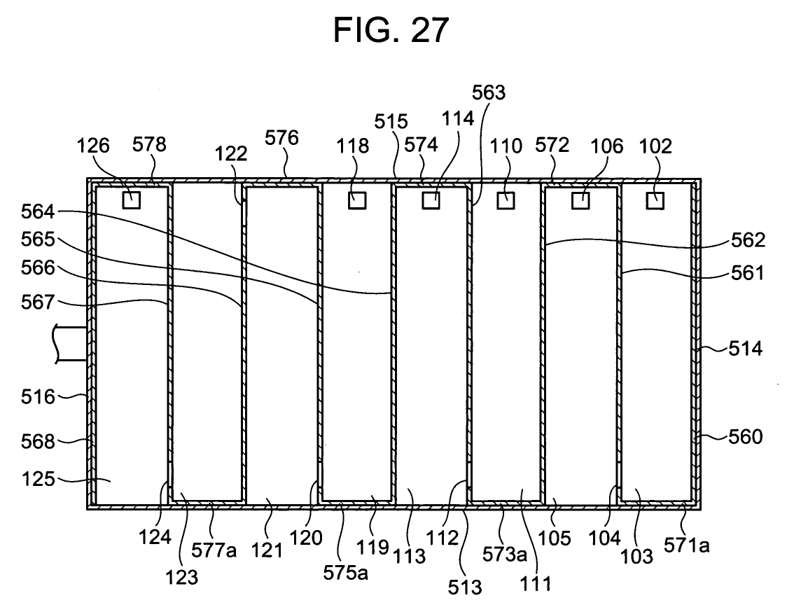

FIG. 27 is a cross-sectional view taken along a line XXVII-XXVII of FIG. 26B.

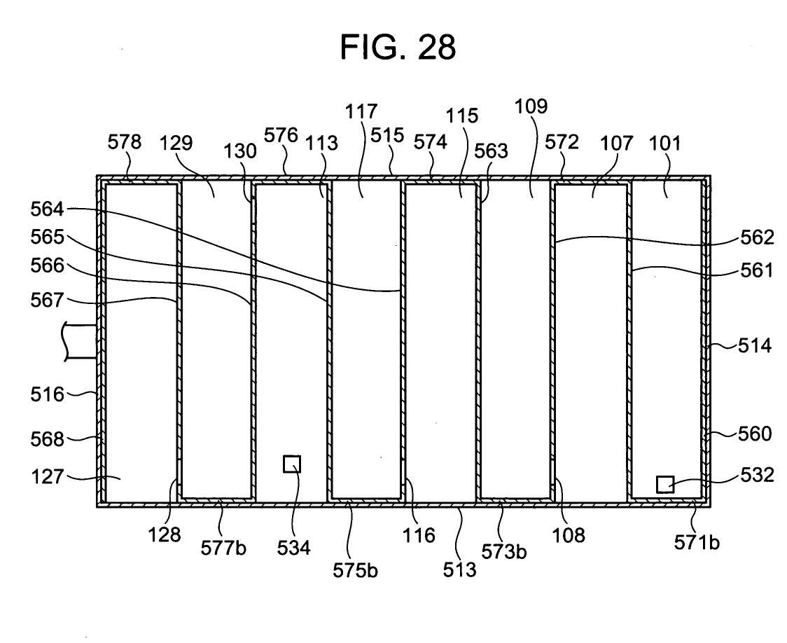

FIG. 28 is a cross-sectional view taken along a line XXVIII-XXVIII of FIG. 26B.

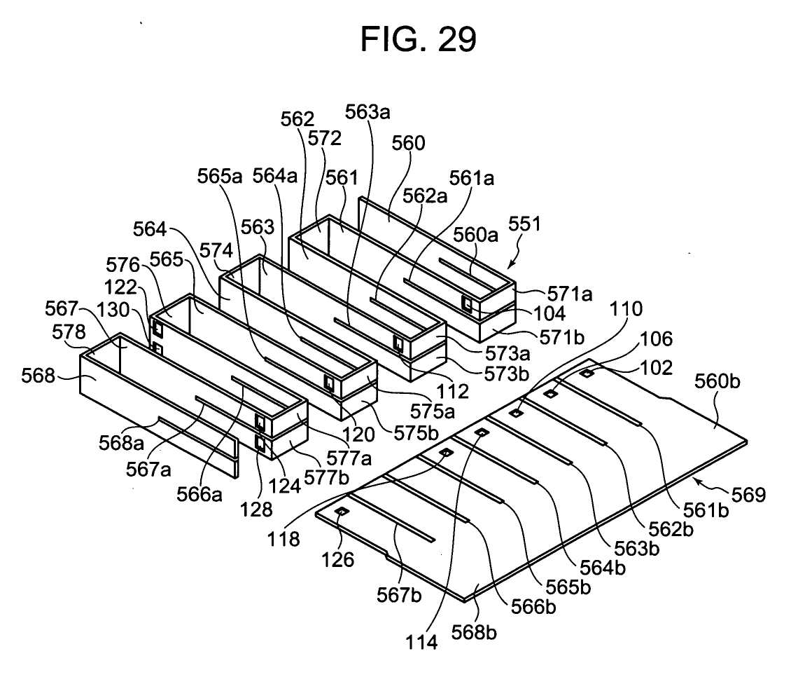

FIG. 29 is an exploded perspective view of a partition member for use in the carbon monoxide remover in the second modification example.

As shown in FIG. 25, the carbon monoxide remover 500C in the second modification example is composed of the box body 511, the bottom plate 530, and a partition member 550. Note that the box body 511 and the bottom plate 530 are similar to those of the first modification example, and a description thereof will be omitted.

As shown in FIG. 29, the partition member 550 is composed of a partition wall 551 and a floor plate 569.

The partition wall 551 is composed of two reinforcement plates 560 and 568, seven partition plates 561, 562, 563, 564, 565, 566 and 567, and coupling plates 571a, 571b, 572, 573a, 573b, 574, 575a, 575b, 576, 577a, 577b and 578.

The reinforcement plates 560 and 568 are arranged along the side plates 514 and 516, respectively.

The partition plates 561, 562, 563, 564, 565, 566 and 567 are provided parallel to the side plates 514 and 516, and divide an inside of the carbon monoxide remover 500C into eight rows.

At the respective center positions of the reinforcement plates 560 and 568 and the partition plates 561, 562, 563, 564, 565, 566 and 567 in the height direction, slits 560a, 561a, 562a, 563a, 564a, 565a, 566a, 567a and 568a are provided parallel to the floor plate 569 from the side plate 513 side. Heights of the slits 560a, 561a, 562a, 563a, 564a, 565a, 566a, 567a and 568a are equal to a thickness of the floor plate 569. Ends of the reinforcement plates 560 and 568 and the partition plates 561, 562, 563, 564, 565, 566 and 567 on the side plate 513 side are vertically divided into halves by the slits 560a, 561a, 562a, 563a, 564a, 565a, 566a, 567a and 568a.

In the first, third and fifth partition plates 561, 563 and 565 from the side plate 514 side, on upper ends thereof on the side plate 513 side, the connection ports 104, 112 and 120 that penetrate through the partition plates 561, 563 and 565 are provided.

In the second and fourth partition plates 562 and 564 from the side plate 514 side, on lower ends thereof on the side plate 513 side, the connection ports 108 and 116 that penetrate through the partition plates 562 and 564 are provided.

In the sixth partition plate 566 from the side plate 514 side, on an end thereof on the side plate 515 side, the two upper and lower connection ports 122 and 130 that penetrate through the partition plate 566 are provided.

In the seventh partition plate 567 from the side plate 514 side, on both upper and lower ends thereof on the side plate 513 side, the connection ports 124 and 128 that penetrate through the partition plate 546 are provided, respectively.

The reinforcement plates 560 and 568 and the partition plates 561, 562, 563, 564, 565, 566 and 567 are coupled to one another by the coupling plates 571a, 571b, 572, 573a, 573b, 574, 575a, 575b, 576, 577a, 577b and 578, and the partition wall 551 with a rectangular wave shape in cross section is formed. The partition wall 551 is disposed so that a wave height direction thereof can be perpendicular to the side plates 513 and 515.

Specifically, the coupling plates 571a and 571b couple the ends of the reinforcement plate 560 and the partition plate 561 on the side plate 513 side to each other. The coupling plate 572 couples the ends of the partition plate 561 and the partition plate 562 on the side plate 515 side to each other. The coupling plates 573a and 573b couple the ends of the partition plate 562 and the partition plate 563 on the side plate 513 side to each other. The coupling plate 574 couples the ends of the partition plates 563 and the partition plate 564 on the side plate 515 side to each other. The coupling plates 575a and 575b couple the ends of the partition plate 564 and the partition plate 565 on the side plate 513 side to each other. The coupling plate 576 couples the ends of the partition plate 565 and the partition plate 566 on the side plate 515 side to each other. The coupling plates 577a and 577b couple the ends of the partition plate 566 and the partition plate 567 on the side plate 513 side to each other. The coupling plate 578 couples the ends of the partition plate 567 and the reinforcement plate 568 on the side plate 515 side to each other.

An upper end of the partition wall 551 is joined to the top plate 512 by welding or brazing.

In a state of being housed in the carbon monoxide remover 500C, the floor plate 569 is provided parallel to the top plate 512 and the bottom plate 530, and vertically divides the inside of the carbon monoxide remover 500C into halves.

On both ends of the floor plate 560 on the side plate 514 side and the side plate 516 side, protruding portions 560b and 568b sandwiched by the slits 560a and 568a of the reinforcement plates 560 and 568 are provided on the side plate 513 side.

As shown in FIG. 29, in the floor plate 569, seven slits 561b, 562b, 563b, 564b, 565b, 566b and 567b from the side plate 515 side are provided at an equal interval in parallel to the partition plates 561, 562, 563, 564, 565, 566 and 567. Widths of the slits 561b, 562b, 563b, 564b, 565b, 566b and 567b are equal to thicknesses of the partition plates 561, 562, 563, 564, 565, 566 and 567, respectively.

Moreover, an end of the floor plate 569 on the side plate 515 side is divided into eight equal portions by the seven slits 561b, 562b, 563b, 564b, 565b, 566b and 567b. Among ends of the eight portions, in the first to fifth and eighth ends from the side plate 514 side, the connection ports 102, 106, 110, 114, 118 and 126 that penetrate through the floor plate 569 are provided.

The slits 561b, 562b, 563b, 564b, 565b, 566b and 567b correspond to the slits 561a, 562a, 563a, 564a, 565a, 566a and 567a of the partition plates 561, 562, 563, 564, 565, 566 and 567, respectively, and are formed so that the sum of lengths of these slits 561b, 562b, 563b, 564b, 565b, 566b and 567b can be longer than lengths of the slits of the partition plates 561, 562, 563, 564, 565, 566 and 567.

The partition plate 551 and the floor plate 569 are combined so that the floor plate 569 can be sandwiched by portions of the slits 561a, 562a, 563a, 564a, 565a, 566a and 567a, that the protruding portions 560b and 568b can be sandwiched by portions of the slits 560a and 568a, and that the partition plates 561, 562, 563, 564, 565, 566 and 567 can be sandwiched by portions of the slits 561b, 562b, 563b, 564b, 565b, 566b and 567b, respectively, and are thereby assembled perpendicularly to each other. Note that such assembled portions may be welded or brazed. By being welded or brazed, the floor plate 569 and the partition plates 561, 562, 563, 564, 565, 566 and 567 can be certainly fixed to each other. Moreover, peripheral edges of the floor plate 569 and the partition plates 561, 562, 563, 564, 565, 566 and 567 abut on inner surfaces of the top plate 12, the bottom plate 530 and the side plates 513 to 516, and are joined thereto by welding or brazing.

As shown in FIG. 27 and FIG. 28, the inside of the carbon monoxide remover 500c is divided by the partition member 550 into the sixteen reaction chambers 101, 103, 105, 107, 109, 111, 113, 115, 117, 119, 121, 123, 125, 127, 129 and 131.

Specifically, the inside of the carbon monoxide remover 500C is divided by the floor plate 569 into an upper stage (between the floor plate 569 and the top plate 512) and a lower stage (between the bottom plate 530 and the floor plate 569). As shown in FIG. 28, the upper stage is divided into the eight reaction chambers 103, 105, 111, 113, 119, 121, 123 and 125 by the partition plates 561, 562, 563, 564, 565, 566 and 567. Moreover, as shown in FIG. 27, the lower stage is divided into the eight reaction chambers 101, 107, 109, 115, 117, 131, 129 and 127 by the partition plates 561, 562, 563, 564, 566 and 567.

The reaction chamber 101 communicates with the outside of the carbon monoxide remover 500C by the introduction port 532, and communicates with the reaction chamber 103 by the connection port 102. Moreover, the reaction chamber 131 communicates with the reaction chamber 129 by the connection port 130, and communicates with the outside of the carbon monoxide remover 500C by the discharge port 534. Each of the other reaction chambers 103, 105, 107, 109, 111, 113, 115, 117, 119, 121, 123, 125, 127 and 129 communicates with the two adjacent reaction chambers by any two of the connection ports 104, 106, 108, 110, 112, 114, 116, 118, 120, 122, 124, 126 and 128.

The passage of the reactant inside of the carbon monoxide remover 500C is similar to that of the carbon monoxide remover 500B of the first modification example. Specifically, the reactant first flows from the introduction port 532 into the reaction chamber 101 inside of the carbon monoxide remover 500C, and thereafter, passes through the connection port 102, the reaction chamber 103, the connection port 104, the reaction chamber 105, the connection port 106, the reaction chamber 107, the connection port 108, the reaction chamber 109, the connection port 110, the reaction chamber 111, the connection port 112, the reaction chamber 113, the connection port 114, the reaction chamber 115, the connection port 116, the reaction chamber 117, the connection port 118, the reaction chamber 119, the connection port 120, the reaction chamber 121, the connection port 122, the reaction chamber 123, the connection port 124, the reaction chamber 125, the connection port 126, the reaction chamber 127, the connection port 128, the reaction chamber 129, the connection port 130, and the reaction chamber 131 in this order, and flows out from the discharge port 534 to the outside of the carbon monoxide remover 500C.

Also in the second modification example, as in the case of the above-described embodiment, the partition wall 551 and the top plate 512 are joined to each other, whereby the top plate 512 can be reinforced. In such a way, when the microreactor module 600 is housed in the heat-insulating package 791 of which inner pressure is reduced, the top plate 512 can be made hardly deformable even if the thickness of the top plate 512 is thinned to an extent to which the top plate 512 is largely deformed in the case of such a structure where the top plate 512 and the partition wall 551 are not joined to each other.

Moreover, in a similar way to the carbon monoxide remover 500B of the first modification example, in the carbon monoxide remover 500C, the cross-sectional dimension of the passage can be reduced, and the diffusion time of the reactant to the catalysts provided on the surface of the passage can be thereby shortened. In addition, the length of the passage can be elongated, and the reaction time can be thereby extended.

Furthermore, the partition member 550 can be formed in such a manner that the partition wall 551 and the floor plate 569 are combined so as to be sandwiched by each other to be thereby assembled perpendicularly to each other. Accordingly, the partition member 550 can be assembled easily.

In order to assemble the carbon monoxide remover 500C, the reforming catalyst is first supported oh the inner surface of the box body 511, the surface of the assembled partition member 550, and the upper surface of the bottom plate 530. Subsequently, the assembled partition member 550 is joined to the inside of the box body 511. Thereafter, the lower ends of the side walls 513 to 516 of the box body 511 and the outer edge of the bottom plate 530 are joined to each other, and the lower opening of the box body 511 is closed by the bottom plate 530.

Note that, in the above-described second modification example, the configuration is adopted, in which the partition member 550 is composed of the partition wall 551 and the floor plate 569, and the inside of the carbon monoxide remover 500C is vertically divided into halves by the floor plate 569. However, the configuration is not limited to the above, and a configuration may be adopted, in which the floor plate 569 is not provided, and the inside of the carbon monoxide remover 500C is not vertically divided.

### MODIFICATION EXAMPLE 3

Next, a description will be made of a third modification example of the microreactor module 600 (reaction apparatus) in the present invention. Note that portions other than a carbon monoxide remover 500D that will be described below are similar to those of the first and second modification examples, and accordingly, a description of the other portions will be omitted.

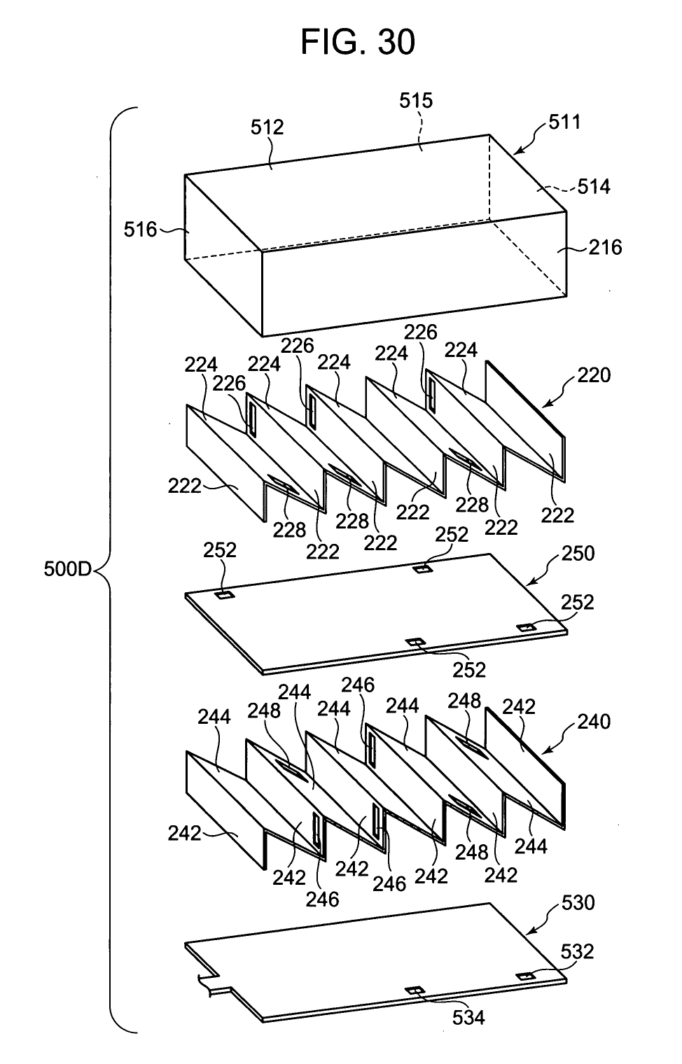

FIG. 30 is an exploded perspective view showing the carbon monoxide remover in the third modification example of the microreactor module of the present invention.

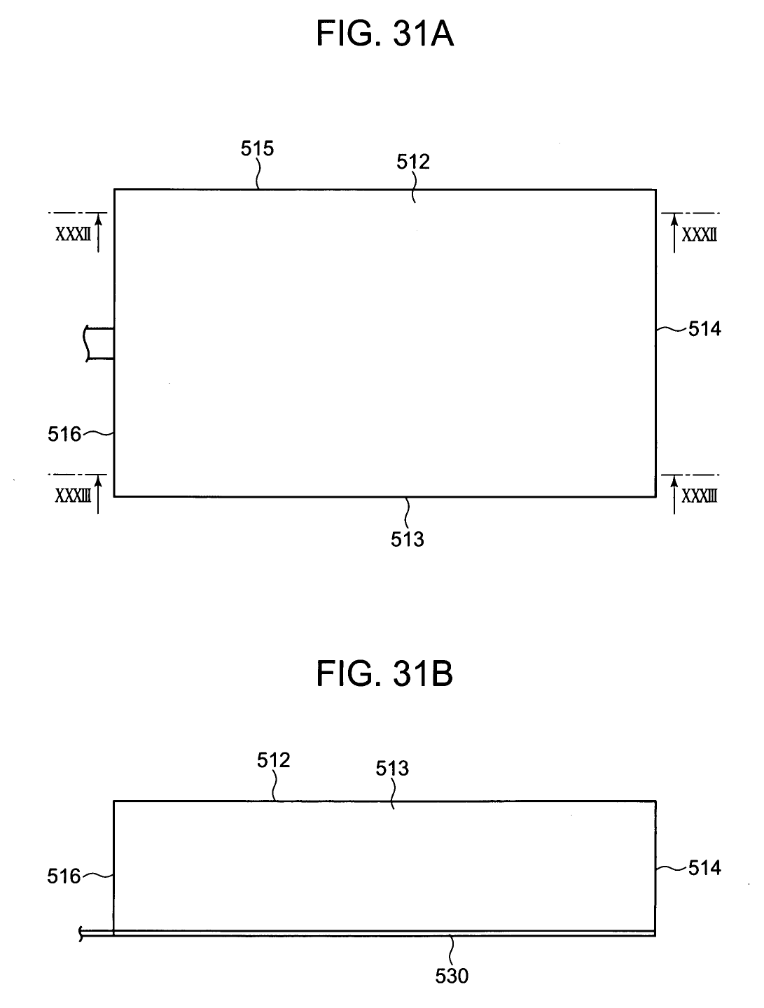

FIG. 31A is a plan view of the carbon monoxide remover in the third modification example, and FIG. 31B is a side view thereof.

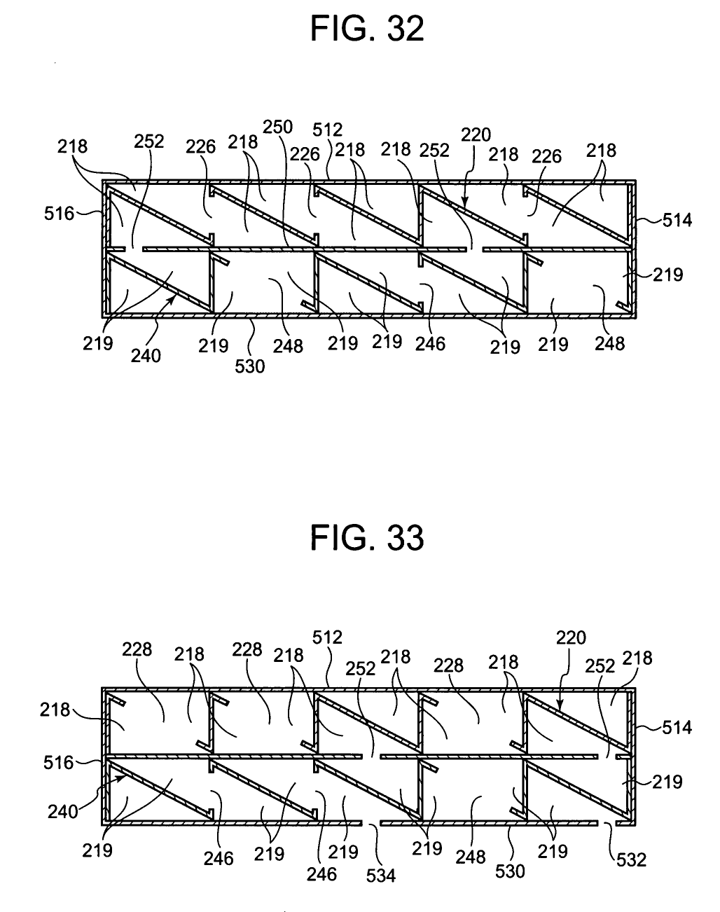

FIG. 32 is an arrow end view of a plane along a cutting plane line XXXII-XXXII of FIG. 31B.

FIG. 33 is an arrow end view of a plane along a cutting plane line XXXIII-XXXIII of FIG. 31B.

This carbon monoxide remover 500D includes the box body 511 of which one surface is open, a floor plate 250 that is housed inside of the box body 511 and partitions a space of the inside of the box body 511 into a bottom-side space and an opening-side space, the cover plate 530 that closes the opening of the box body 511, a partition plate 220 housed in the bottom-side space between the two spaces partitioned by the floor plate 250, and a partition plate 240 housed in the opening-side space therebetween. Note that the box body 511 and the cover plate 530 are similar to those of the first and second modification examples, and accordingly, a description thereof will be omitted.

The partition plate 220 has a shape of a corrugate plate in which a serpentine with a triangular wave shape is formed. Specifically, the partition plate 220 is a plate formed by alternately folding a band-like plate, in which connected regions of first partitioned portions 222 and second partitioned portions of the partition plate 220 become folded edge lines. In a similar way to the partition plate 220, the partition plate 240 also has a shape of a corrugate plate in which the serpentine with the triangular shape is formed, in which connected regions of first partitioned portions 242 and second partitioned portions 244 of the partition plate 240 become folded edge lines.

In the partition plate 220 and the partition plate 240, the numbers of folds are equal to each other, and for example, wave lengths and wave heights of the triangular waves are also equal to each other.

The partition plate 220 is housed in the space between the floor plate 250 and the top plate 512 so that the wave height direction thereof can be parallel to the side plates 513 to 516. The one-side folded edge lines of the partition plate 220 are brought into line contact with the top plate 512 of the box body 511, and are joined thereto by welding or brazing. In such a way, also in the third modification example, as in the case of the above-described embodiment, the top plate 512 can be reinforced, and when the microreactor module 600 is housed in the heat-insulating package 791 of which inner pressure is reduced, the top plate 512 can be made hardly deformable even if the thickness of the top plate 512 is thinned to an extent to which the top plate 512 is largely deformed in the case of such a structure where the top plate 512 and the partition plate 220 are not joined to each other.

Both edges of the wave shape of the partition plate 220 individually abut on the side plates 513 and 515, and the partitioned portions 222 and 222 on both sides of the partition plate 220 are brought into surface contact with the side plates 514 and 516, respectively.

The floor plate 250 is fitted into a middle portion of the box body 511, and the other-side folded edge lines of the partition plate 220 are brought into line contact with the floor plate 250. As described above, the partition plate 220 is housed in the space between the top plate 512 and the floor plate 250 in the box body 511, whereby the space concerned is partitioned into a plurality of reaction chambers 218, 218 . . . by the partition plate 220.

The partition plate 240 is housed in the space between the floor plate 250 and the cover plate 530 so that the wave height direction thereof can be parallel to the side plates 513 to 516. The one-side folded edge lines of the partition plate 240 are brought into line contact with the floor plate 250. Moreover, the other-side folded edge lines of the partition plate 240 are brought into line contact with the cover plate 530. The cover plate 530 closes the opening of the box body 511.

The partition plate 240 is housed in the space between the cover plate 530 and the floor plate 250 in the box body 511, whereby the space concerned is partitioned into a plurality of reaction chambers 219, 219 . . . by the partition plate 240. The lower partition plate 240 overlaps with the upper partition plate 220 while sandwiching the floor plate 250 therebetween, and the upper reaction chambers 218 are partitioned from the lower reaction chambers 219 by the floor plate 250.

First connection ports 226 are formed in the first partitioned portions 222 of the partition plate 220, and the adjacent reaction chambers 218 and 218 communicate with each other through any of the connection ports 226. First connection ports 228 are formed in the second partitioned portions 224 of the partition plate 220, and the adjacent reaction chambers 218 and 218 communicate with each other through any of the connection ports 228. Also with regard to the partition plate 240, second connection ports 246 are formed in the first partitioned portions 242, second connection ports 248 are formed in the second partitioned portions 244, and the adjacent reaction chambers 219 and 219 communicate with each other through either the connection port 226 or the connection port 228.

A plurality of third connection ports 252, 252 . . . are formed in the floor plate 250, and the vertically adjacent reaction chambers 218 and 219 communicate with each other through the connection ports 252. By the connection ports 226, 228, 246, 248 and 252, these reaction chambers 218, 218 . . . and these reaction chambers 219, 219 . . . form a predetermined continuous serpentine passage.

In the cover plate 530, there are formed the introduction port 532 that communicates with one side of the reaction chamber 219 becoming a terminal end of the continuous serpentine passage among the plurality of reaction chambers 219, 219 . . . , and the discharge port 534 that communicates with the other side of the reaction chamber 219 concerned.

In order to assemble the carbon monoxide remover 500D, the reforming catalyst is first supported on the inner surface of the box body 511, the surfaces of the partition plate 220 and 240 and the floor plate 250, and the upper surface of the bottom plate 530. Subsequently, the partition plate 220 is housed inside of the box body 511, and the folded edge lines of the partition plate 220 are joined to the top plate 512. Subsequently, the floor plate 250 and the partition plate 240 are sequentially housed inside of the box body 511. Thereafter, the lower ends of the side walls 513 to 516 of the box body 511 and the outer edge of the bottom plate 530 are joined to each other, and the lower opening of the box body 511 is closed by the bottom plate 530.

Note that, further, the folded edge lines of the partition plate 220 may be joined to the floor plate 250 by welding or the like, both edges of the wave shape of the partition plate 220 may be joined to the side plates 513 and 515 by welding, and the partitioned portions 222 and 222 on both sides of the partition plate 220 may be joined to the side plates 514 and 516 by welding or the like. Moreover, the folded edge lines of the partition plate 240 may be joined to the floor plate 250 and the cover plate 530 by welding or the like, both edges of the wave shape of the partition plate 240 may be joined to the side plates 513 and 515 by welding, and the partitioned portions 242 and 242 on both sides of the partition plate 240 may be joined to the side plates 514 and 516 by welding or the like. These constituents are joined together by welding or the like as described above, whereby air tightness of the respective reaction chambers 118 and 119 can be further enhanced, and rigidity of the carbon monoxide remover 500D can be further enhanced.

Note that, in the above-described third modification example, the configuration is adopted, in which the carbon monoxide remover 500D includes the partition plate 220, the partition plate 240, and the floor plate 250, and the inside of the carbon monoxide remover 500D is vertically divided into halves by the floor plate 250. However, the configuration is not limited to the above, and a configuration may be adopted, in which the floor plate 250 is not provided, and the inside of the carbon monoxide remover 500D is not vertically divided.

As described above, according to the present invention, the partition plate for partitioning the space in the box body of the reaction container and the op plate are joined to each other, whereby the top plate can be reinforced. In such a way, the wall thickness of the reaction container can be thinned while maintaining the strength of the reaction container so as to suppress the deformation caused by the pressure difference between the inside and outside of the reaction container when the reaction container is housed in the heat-insulating container of which inner pressure is reduced. Moreover, in such a way, the weight of the reaction container can be reduced. In addition, the heat capacity of the reaction container can be reduced, whereby the activation time taken until the reaction container is set at the predetermined temperature by being heated can be shortened.

The entire disclosure of Japanese Patent Application No.2006-69480 filed on Mar. 14, 2006 including specification, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A reaction apparatus, comprising:
a reaction container to receive a supply of a reactant and to cause a reaction of the reactant supplied thereto,
wherein the reaction container comprises:
a hollow box member having a first plate wherein a supplying passage of the reactant is formed, a second plate opposite to the first plate, and a third plate provided continuously with an edge of the first plate and an edge of the second plate; and
at least one partition plate which is disposed to partition a space inside the box member and to form a reaction passage through which the reactant flows, and are joined to an inner surface of the second plate.

2. The reaction apparatus according to claim 1, wherein a rigidity of the second plate is lower than the rigidity of the first plate.

3. The reaction apparatus according to claim 1, wherein the second plate and the partition plate are joined to each other by either welding or brazing.

4. The reaction apparatus according to claim 1, wherein the second plate, the third plate and the partition plate are formed of a metal material.

5. The reaction apparatus according to claim 1, wherein the partition plate has a diaphragm portion provided substantially in a perpendicular direction to the second plate.

6. The reaction apparatus according to claim 5, wherein the partition plate has, at an end of the diaphragm portion, a joint portion provided substantially perpendicularly to the diaphragm portion, and the joint portion and the second plate are joined to each other.

7. The reaction apparatus according to claim 1, wherein a first through area that forms the reaction passage is provided in the partition plate.

8. The reaction apparatus according to claim 1, wherein the partition plate has a rectangular wave shape, a wave height direction of the rectangular wave being set parallel to the second plate.

9. The reaction apparatus according to claim 1, wherein the partition plate has a triangular wave shape, a wave height direction of the triangular wave being set perpendicular to the second plate.

10. The reaction apparatus according to claim 1, further comprising a parallel partition plate that is disposed parallel to the second plate in the reaction container and partitions the space inside the box member.

11. The reaction apparatus according to claim 10, wherein a second through area that forms the reaction passage is provided in the parallel partition plate.

12. The reaction apparatus according to claim 1, further comprising a base plate that is joined to the first plate and reinforces the first plate.

13. The reaction apparatus according to claim 1, further comprising a heat-insulating container to house the reaction container, the heat-insulating container having an inner space of which a pressure is set lower than an atmospheric pressure.

14. The reaction apparatus according to claim 1, comprising:
a first reaction portion to cause a reaction of a reactant at a first temperature;
a second reaction portion to cause a reaction of the reactant at a second temperature which is lower than the first temperature; and
a coupling portion to transfer the reactant and a product between the first reaction portion and the second reaction portion,
wherein at least one of the first reaction portion and the second reaction portion is formed by including the reaction container.

15. The reaction apparatus according to claim 14, wherein
a first product is generated by receiving a supply of a first reactant to the first reaction portion,
a second product is generated by receiving a supply of the first product to the second reaction portion,
the first reactant is an gaseous mixture in which water and a fuel containing hydrogen atom in a composition are vaporized,
the first reaction portion is a reformer which causes a reforming reaction of the first reactant,
hydrogen and carbon monoxide are contained in the first product, and
the second reaction portion is a carbon monoxide remover to remove carbon monoxide contained in the first product.

16. A reaction apparatus, comprising:
a reaction container to receive a supply of a reactant and to cause a reaction of the reactant supplied thereto; and
a heat-insulating container to house the reaction container, the heat-insulating container having an inner space of which a pressure is set lower than an atmospheric pressure,
wherein the reaction container comprises:
a hollow box member composed by having a first plate wherein a supplying passage of the reactant is formed, a second plate opposite to the first plate, and a third plate provided continuously with an edge of the first plate and an edge of the second plate; and
at least one partition plate which is disposed to partition a space inside the box member and to form a reaction passage through which the reactant flows, and are joined to an inner surface of the second plate.

17. The reaction apparatus according to claim 16, wherein a rigidity of the second plate is lower than the rigidity of the first plate.

18. The reaction apparatus according to claim 16, wherein the second plate and the partition plate is joined to each other by either welding or brazing.

19. The reaction apparatus according to claim 16, wherein the second plate, the third plate and the partition plate is formed of a metal material.

20. The reaction apparatus according to claim 16, wherein the partition plate has a diaphragm portion provided substantially in a perpendicular direction to the second plate.

21. The reaction apparatus according to claim 20, wherein the partition plate has, at an end of the diaphragm portion, a joint portion provided substantially perpendicularly to the diaphragm portion, and the joint portion and the second plate are joined to each other.

22. A reaction apparatus, comprising:
a reaction container to receive a supply of a reactant and to cause a reaction of the reactant supplied thereto,
wherein the reaction container comprises:
a hollow box member composed by having a first plate wherein a supplying passage of the reactant is formed, a second plate opposite to the first plate wherein a rigidity of the second plate is lower than the rigidity of the first plate, and a third plate provided continuously with an edge of the first plate and an edge of the second plate;
at least one partition plate which is disposed to partition a space inside the box member and to form a reaction passage through which the reactant flows, the partition plate including a diaphragm portion provided substantially in a perpendicular direction to the second plate and a joint portion provided at an end of the diaphragm portion substantially perpendicularly to the diaphragm portion, and the joint portion being joined to an inner surface of the second plate.
